(19) United States
(12) Patent Application Publication
(10) Pub. No.: US 2024/0254316 A1
(43) Pub. Date: Aug. 1, 2024

(54) USE OF AT LEAST ONE SULFUR-CONTAINING AMINO ACID FOR STABILIZING RECYCLED THERMOPLASTICS, STABILIZED RECYCLED THERMOPLASTIC, STABILIZER COMPOSITION, MASTERBATCH, AND MOLDING COMPOUND OR MOLDED PART

(71) Applicant: FRAUNHOFER-GESELLSCHAFT ZUR FÖRDERUNG DER ANGEWANDTEN FORSCHUNG E.V., München (DE)

(72) Inventors: Rudolf PFAENDNER, Darmstadt (DE); Jannik MAYER, Darmstadt (DE); Elke METZSCH-ZILLIGEN, Darmstadt (DE)

(73) Assignee: FRAUNHOFER-GESELLSCHAFT ZUR FÖRDERUNG DER ANGEWANDTEN FORSCHUNG E.V., München (DE)

(21) Appl. No.: 18/561,878

(22) PCT Filed: May 18, 2022
(86) PCT No.: PCT/EP2022/063395

§ 371 Date: Nov. 17, 2023

(30) Foreign Application Priority Data
May 20, 2021 (DE) 10 2021 205 168.5

(51) Int. Cl. C08K 5/372; C08J 3/22; C08K 5/134; C08K 5/524; C08L 23/12

(52) U.S. Cl. CPC C08K 5/3725; C08J 3/226; C08K 5/134; C08K 5/524; C08L 23/12; C08J 2323/12; C08L 2201/08; C08L 2207/066; C08L 2207/20

(57) ABSTRACT

The invention relates to the use of at least one sulfur-containing amino acid for stabilizing recycled thermoplastics, in particular against oxidative, thermal, and/or actinic degradation, to a recycled thermoplastic composition containing or consisting of at least one recycled thermoplastic and at least one sulfur-containing amino acid, to a molded part which can be produced from the recycled thermoplastic composition according to the invention, to a stabilizer composition, to a masterbatch, and to a stabilizing method, in particular an oxidative, thermal, and/or actinic stabilizing method for stabilizing recycled thermoplastics by adding or incorporating at least one sulfur-containing amino acid, a stabilizer composition according to the invention, or a masterbatch according to the invention to a recycled thermoplastic.

Plastic recyclates are a growing market and an important element in the circular economy of raw materials, with the objective ideally being for recyclates to replace virgin plastics with an identical or at least comparable property profile. However, recyclate from the production of plastics parts (so-called “post-industrial” recyclates) and from collections of used plastics (so-called “post-consumer” recyclates) differ chemically from virgin plastics. During the initial processing steps (e.g., by compounding, extrusion or injection moulding) and the application often over many years and in demanding fields of use (e.g., high temperatures and/or UV light), irreversible changes occur in the polymer chains due to mechano-chemical, chemical or light-induced processes (see for example R. Pfaendner et al., Angew. Makromol. Chemie 1995, 232, 193-227, R. Pfaendner, Kunststoffe International 12/2015, 41-44, J. Pospisil et al., Pol. Degr. Stab. 1995, 48, 351-358, La Mantia, Macromol. Symp. 135, 157-165 (1998)). Radical reactions in the presence of oxygen, generally referred to as autoxidation, generate new chemical groups in the polymer chain and/or change the composition of the polymer at molecular level. The chemical modifications resulting from is the damage process and the ageing process are mainly the formation of hydroperoxide groups, aliphatic carbonyl groups, unsaturated carbonyl groups, alcohol groups, acid groups, ester groups and peracid groups, i.e., structures that usually are not present in virgin polyolefins, for example, and are formed as a result of oxidation processes (J. Pospisil et al. Macromol. Symp. 135, 247-263 (1998)). Furthermore, recyclates often contain unsaturated structures, i.e., vinylene, vinylidene and vinyl groups, wherein the former may even be present in conjugated form. Unsaturated structures develop here by chain cleaving and disproportionation reactions (H. Hinsken et al., Pol. Degr. Stab. 1991, 34, 279-293). The concentration of these newly formed groups increases with the processing intensity (process control, shear strain, temperature), the field of application (UV light, high temperatures, contact media) and the application time. In addition, the formation of these structures may be catalyzed in oxidation processes and subsequent reactions by metals and by pigments.

The structural inhomogeneities of a recyclate influence the plastic properties, such as the mechanical properties or the morphology. Due to the newly formed chemical structures, recyclates or pre-damaged plastics are more sensitive to oxidation than virgin material, as these structures act as initiator sites for further oxidation or as prodegradants (A. S. Maxwell, Pol. Eng. Sci. 2008, 381-385, I. H. Craig, J. R. White, J. Mater. Sci. 2006, 41, 993-1006, S. Luzuriaga et al. Pol. Degr. Stab. 2006, 91, 1226-1232).

Furthermore, it has been demonstrated that the degradation rate of a polymer depends on the concentration of chromophores “impurities” (M. S. Rabello, J. R. White, Polym. Degr. Stab. 56, 55 (1997)). The concentration of the described chemical structures in the recyclates may increase here by several orders of magnitude compared to the virgin material.

To achieve an improvement in the quality of plastic recyclates, post-stabilization with selected stabilizers such as antioxidants is an essential method. The stabilizers used protect is the recyclate from further oxidative (or photooxidative) damage or at least delay it. Since virgin plastics and plastic recyclates differ significantly chemically as described and plastic recyclates are more sensitive to oxidation due to the described pre-damage and initiator sites, it is a challenging task to develop efficient stabilizers for an efficient stabilization of plastic recyclates. Due to the described structural deviations of the recyclate and the virgin material, the optimized stabilizer composition for a recyclate also differs from the stabilization composition of the virgin material (see e.g., R. Pfaendner, Kunststoffe International 12/2015, 41-44).

Due to the nowadays recognized differences between virgin plastics and plastic recyclates, special recyclate stabilizer compositions are known and also available as commercial products (e.g., Recyclobyk products from the company BYK-Chemie GmbH, Wesel). Known technical stabilization solutions that take into account the requirements of recyclates are described, for example, in the following patents/patent applications: Stabilization composition consisting of a phenolic antioxidant, a phosphite and a fatty acid salt (EP 0662101).

Stabilization composition consisting of a phenolic antioxidant, a phosphite and a metal oxide such as calcium oxide (U.S. Pat. Nos. 6,525,158, 6,251,972). Stabilization composition consisting of a phenolic antioxidant and a polyfunctional epoxy (EP 0702704).

Stabilization by a macrocyclic piperidine (U.S. Pat. No. 5,789,470).

Stabilization composition consisting of a secondary aromatic amine and a polyfunctional epoxide (WO 97/30112).

Decolourization of damaged polyolefins by a hydroxylamine (EP 0470048)

Mixture of antioxidants, lubricants, anti-blocking agents, UV stabilizers and antistatic agents for recyclate films (DD 288161)

Stabilization composition for mixed plastics consisting of a phenolic antioxidant and a phosphite/phosphonite (EP 0506614)

In more recent times, stabilization systems for recyclates have also been described which are based in particular partly or completely on renewable raw materials and contain selected sugar derivatives as active components:

Stabilizing composition containing alditols or cyclitols (WO 2019063550)

Stabilizing composition containing compounds capable of reacting with carbonyl groups and primary and/or secondary antioxidants (WO 2020152337)

Stabilizing composition containing substituted sugar molecules (WO2020193563)

Furthermore, sulphur-containing amino acids have been described as components in virgin plastics:

U.S. Pat. Nos. 3,859,250 and 510,458: Stabilization of butadiene-styrene block copolymers with a sulphur-containing amino acid

EP 062362: Stabilization of PVC by amino acid-metal complexes

GB 2562466, WO 2018202791: Stabilization of polymers and hot-melt adhesives by antioxidants and buffer agents, wherein metal phosphates and amino acids are mentioned as buffer substances.

Today, it may be assumed that the importance of stabilization systems made from renewable raw materials will increase in the future, as will the importance of polymers made from renewable raw materials, as they are able to achieve a favourable ecological balance through a reduced CO₂ input from the raw materials and thus contribute to decarbonization.

However, for the long-term stabilization of plastics, e.g., at elevated temperatures, sulphides such as thioesters or disulphides are often used as synergists (e.g., C. Kröhnke et al, Antioxidants in Ullman's Encyclopedia of Industrial Chemistry). These thiosynergists, e.g., in the form of distearyl dithiopropionate, have also been exemplified in some cases as stabilizers for recyclates (e.g., EP 0506614, A. Hermann et al, Kunststoffe 2000, 90, 80-83, BE 1007218, JP 4793005, JP 2004217734, CN 108929482, CN 108148281, CN 102993538). For the post-stabilization of a plastic recyclate, however, it would be desirable if a powerful thiosynergist from renewable raw materials were available, so that it would be possible to offer a complete stabilization system consisting of primary and secondary antioxidants and for the long-term stabilization of polymers from renewable raw materials. This object could be achieved with the use of sulphur-containing amino acids such as methionine, cystine and cysteine for the post-stabilization of recyclates. Methionine is an amino acid found in many proteins and may be obtained by biotechnological processes (see e.g., T. Wilke. Appl. Microbiol. Biotechnol. 2014, 98, 9893-9914. Biotechnological possibilities also exist for cysteine (see e.g., M. Wada et al., Appl. Microbiol. Biotechnol. 2006, 73, 48-54).

Proceeding from the prior art, it was therefore the object of the present invention to provide new stabilizers or stabilizer compositions and new methods for stabilizing plastic recyclates which are highly effective, environmentally friendly and have a favourable cost structure.

This object is achieved with the features of the independent claims. The respective dependent claims describe advantageous developments.

In a first aspect, the invention thus relates to the use of at least one sulphur-containing amino acid for stabilizing thermoplastic recyclates, in particular against oxidative, thermal and/or actinic degradation.

Surprisingly, it could be found that the addition of sulphur-containing amino acids is particularly suitable for stabilizing thermoplastic recyclates against oxidative, thermal and/or actinic degradation. The stabilizers are cost-effective, environmentally friendly and have a high degree of efficacy.

According to a preferred embodiment, the at least one sulphur-containing amino acid, in relation to the totality of the thermoplastic recyclates, is used in a weight ratio of 0.01 to 10.00 wt. %, preferably 0.02 to 5.00 wt. %, particularly preferably 0.05 to 2.00 wt. %.

According to a further preferred embodiment, the at least one sulphur-containing amino is acid is selected from the group consisting of methionine or a methionine derivative or cystine, as well as alkali, alkaline earth, Al or Zn salts thereof.

Exemplary sulphur-containing amino acids have the following structures:

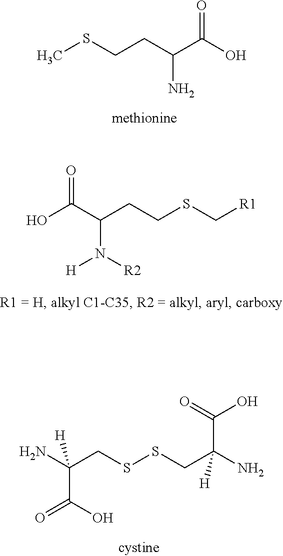

Methionine and/or cystine is very particularly preferred.

It is particularly advantageous if the at least one sulphur-containing amino acid is used in combination with at least one primary and/or secondary antioxidant, preferably in a weight ratio of 10:1 to 1:10, more preferably 5:1 to 1:5, particularly preferably 2:1 to 1:2.

Advantageously, the at least one primary antioxidant is selected here from the group consisting of phenolic antioxidants, (semi-)aromatic amines, hydroxylamines, lactones and isoindolo[2,1-A]quinazolines and mixtures and combinations thereof.

Primary antioxidants act as H-donors and as radical scavengers and thus interrupt the radical autoxidation process in polymers. Suitable primary antioxidants are phenolic antioxidants, (semi-)aromatic amines, hydroxylamines and lactones.

Suitable phenolic antioxidants are, for example:
alkylated monophenols, such as 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, linear or branched nonylphenols such as 2,6-dinonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof;
alkylthiomethylphenols, such as 2,4-dioctylthiomethyl-6-tert-butylphenol, 2,4-dioctylthiomethyl-6-methylphenol, 2,4-dioctylthiomethyl-6-ethyl phenol, 2,6-didodecylthiomethyl-4-nonylphenol;
hydroquinones and alkylated hydroquinones, such as 2,6-di-tert-butyl-4-methyoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxylphenyl)adipate;
tocopherols, such as α-, β-, γ-, δ-tocopherol and mixtures thereof (vitamin E);
hydroxylated thiodiphenyl ethers, such as 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulphide;
alkylidene bisphenols, such as 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methyl benzyl)-4-nonylphenol], 2,2′-methylenebis[6-(α,α-dimethylbenzyl)-4-nonylphenol], 4,4′-methylenebis(2,6-di-tert-butylphenol, 4,4′-methylenebis(6-tert-butyl-2-methylphenol), 1,1-bis(5-tert-butyl-4-hydroxy-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3′-tert-butyl-4′-hydroxyphenyl)butyrate], bis(3-tert-butyl-4-hydroxy-5-methylphenyl)dicyclopentadiene, bis[2-(3′-tert-butyl-2′-hydroxy-5′-methylbenzyl)-6-tert-butyl-4-methylphenyl]terephthalate, 1,1-bis(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra(5-tert-butyl-4-hydroxy-2-methylphenyl)pentane; O-, N- and S-benzyl compounds such as 3,5,3′,5′-tetra-tert-butyl-4,4′-dihydroxy dibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine bis(4-tert-butyl-3-hydroxy-2,6-dimethylbenzyl)dithioterephthalate, bis(3,5-di-tert-butyl-4-hydroxybenzyl)sulphide, isooctyl-3,5-di-tert-butyl-4-hydroxybenzylmercaptoacetate;
hydroxybenzylated malonates, such as dioctadecyl-2,2-bis(3,5-di-tert-butyl-2-hydroxybenzyl)malonate, dioctadecyl-2-(3-tert-butyl-4-hydroxy-5-methylbenzyl)malonate, didodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate;
aromatic hydroxybenzyl compounds, such as 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol;
triazine compounds, such as 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxphenylethyl)-1,3,5-triazine, 1,3,5-tris(3,5-di-tert-butyl-4-hydroyphenylpropionyl)hexahydro-1,3,5-triazine, 1,3,5-tris(3,5-dicyclohexyl-4-hydroxybenzyl)isocyanurate;
benzyl phosphonates, such as dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid; acylaminophenols, such as 4-hydroxylauranilide, 4-hydroxystearanilide, octyl-N-(3,5-di-tert-butyl-4-hydroxyphenyl)carbamate;
esters of β-(3,5-di-tert-butyl-4-hydroxyphenyl)propionic acid with mono- or polyvalent alcohols, for example methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane;
esters of β-(5-tert-butyl-4-hydroxy-3-methylphenyl)propionic acid with mono- or polyvalent alcohols, for example: methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octan, 3,9-bis[2-{3-(3-tert-butyl-4-hydroxy-5-methylphenyl)propionyloxy}-1,1-dimethylethyl]-2,4,8,10-tetraoxaspiro[5.5]undecane;
esters of β-(3,5-dicyclohexyl-4-hydroxyphenyl)propionic acid with monovalent or polyvalent is alcohols, for example methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane;
esters of (3,5-di-tert-butyl-4-hydroxyphenyl)acetic acid with mono- or polyvalent alcohols, for example methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane;
amides of β-(3,5-di-tert-butyl-4-hydroxyphenyl)propionic acid such as N,N′-bis(3,5-di-tert-butyl-4-hydroxyphenylpropionyl)hexamethylene diamide, N,N′-bis(3,5-di-tert-butyl-4-hydroxyphenylpropionyl)hexamethylene diamide, N,N′-bis(3,5-di-tert-butyl-4-hydroxyphenylpropionyl)hexamethylene diamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1, distributed by Uniroyal); ascorbic acid (vitamin C).

Particularly preferred phenolic antioxidants are the following structures:

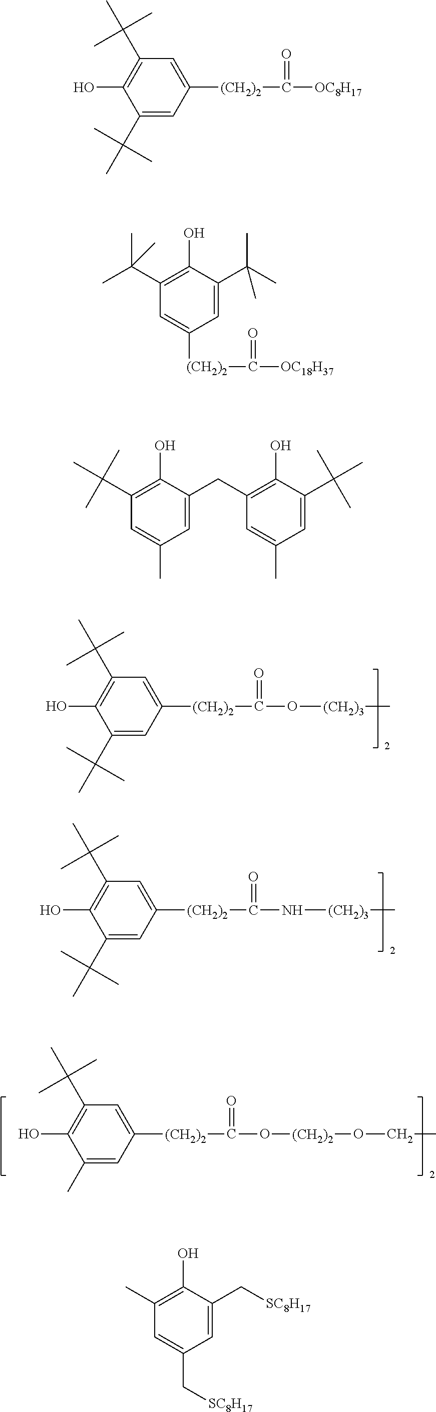

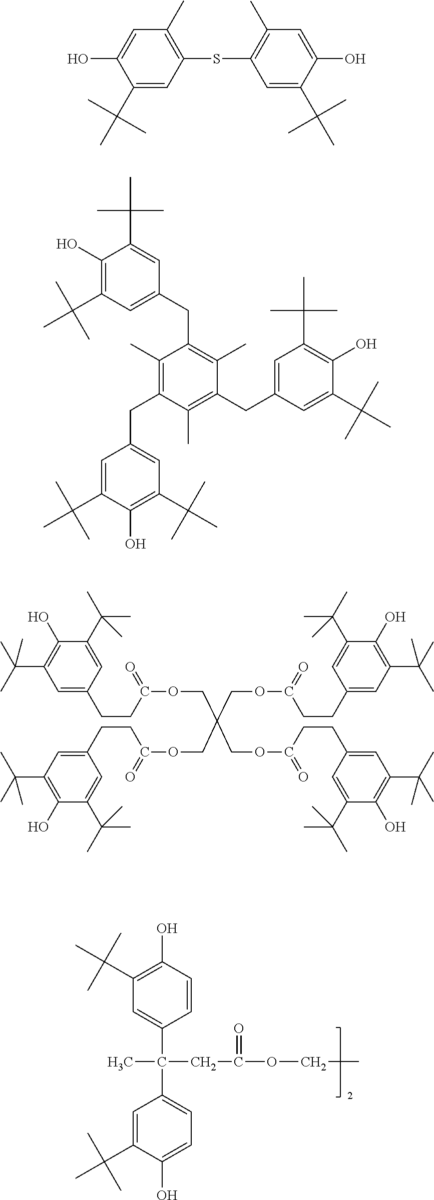

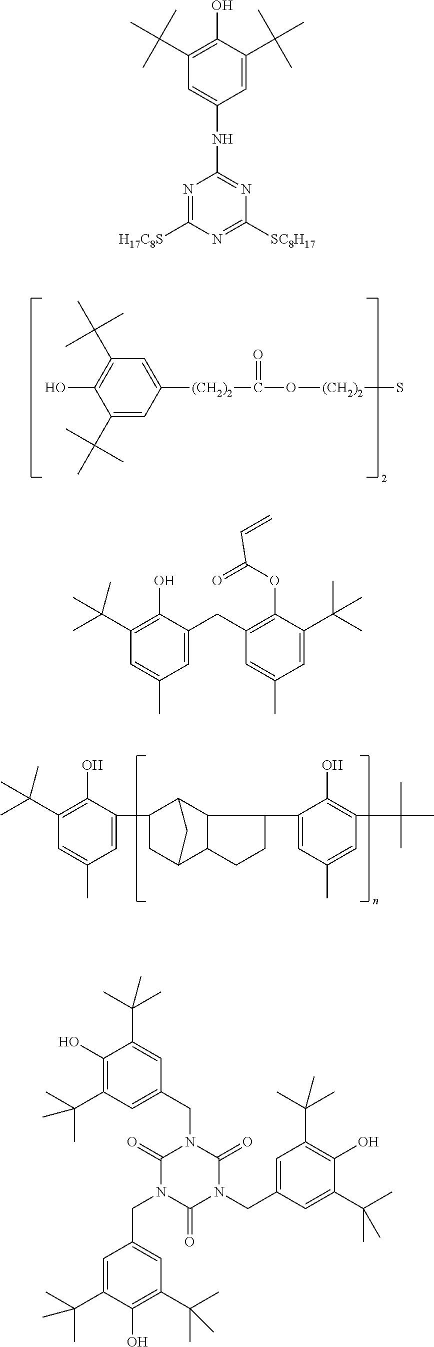

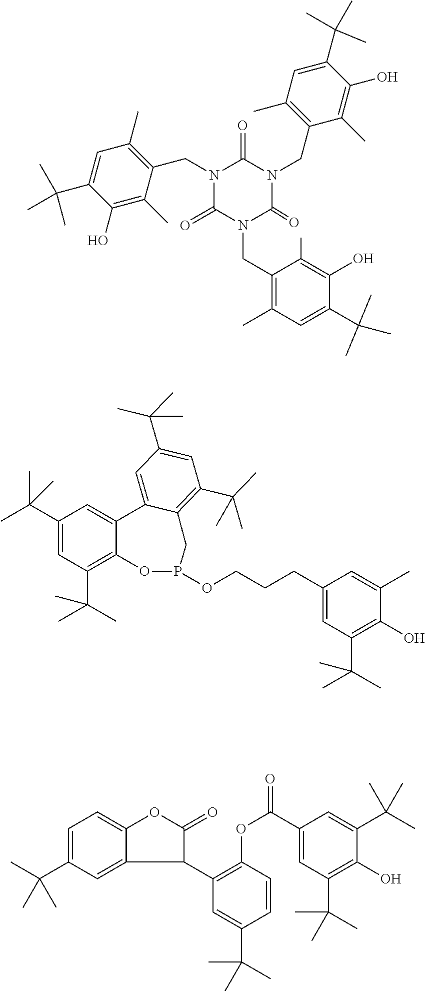

Further particularly preferred phenolic antioxidants are based on sustainable raw materials such as e.g., tocopherols (vitamin E), tocotrienols, tocomonoenols, carotenoids, hydroxytyrosol, flavonols such as e.g., chrysin, quercetin, hesperidin, neohesperidin, naringin, morin, camphor oil, fisetin, anthocyanins such as e.g., delphinidin and malvidin, curcumin, carnosic acid, carnosol, rosmarinic acid, resveratrol and tannins.

Suitable aminic antioxidants are, for example: N,N′-di-isopropyl-p-phenylene diamine, N,N′-di-sec-butyl-p-phenylene diamine, N,N′-bis(1,4-dimethylpentyl)-p-phenylene diamine, N,N′-bis(1-ethyl-3-methylpentyl)-p-phenylene diamine, N,N′-bis(1-methylheptyl)-p-phenylene diamine, N,N′-dicyclohexyl-p-phenylene diamine, N,N′-diphenyl-p-phenylene diamine, N,N′-bis(2-naphthyl)-p-phenylene diamine, N-isopropyl-N′-phenyl-p-phenylene diamine, N-(1,3-dimethylbutyl)-N′-phenyl-p-phenylene diamine, N-(1-methylheptyl)-N′-phenyl-p-phenylene diamine, N-cyclohexyl-N′-phenyl-p-phenylene diamine, 4-(p-toluene sulfamoyl)diphenylamine, N,N′-dimethyl-N,N′-di-sec-butyl-p-phenylene diamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylamino-phenol, bis(4-methoxyphenyl)amine, 2,6-di-tert-butyl-4-dimethylaminomethyl-phenol, 2,4′-diaminodiphenylmethane, 4,4′-diaminodiphenylmethane, N,N,N′,N′-tetra-methyl-4,4′-diaminodiphenylmethane, 1,2-bis[(2-methyl-phenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyl-diphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octylphenothiazinene, N-allylphenothiazine, N,N,N′,N′-tetraphenyl-1,4-diaminobut-2-ene and mixtures or combinations hereof.

Preferred aminic antioxidants are: N,N′-diisopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine

Particularly preferred aminic antioxidants are the structures:

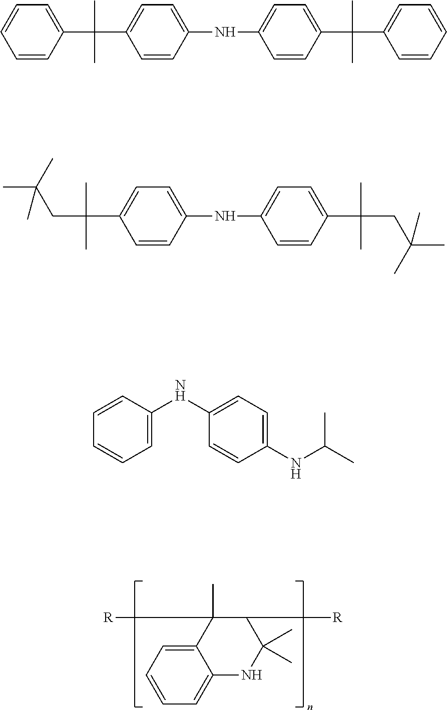

Preferred hydroxylamines or N-oxides (nitrones) are, for example, N,N-dialkylhydroxylamines, N,N-dibenzylhydroxylamine, N,N-dilaurylhydroxylamine, N,N-distearylhydroxylamine, N-benzyl-α-phenylnitrone, N-octadecyl-α-hexadecylnitrone, as well as Genox EP (SI Group) according to the formula:

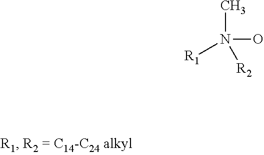

Suitable lactones are benzofuranones and indolinones such as e.g., 3-(4-(2-acetoxyethoxy)phenyl]-5,7-di-tert-butyl-benzofuran-2-one, 5,7-di-tert-butyl-3-[4-(2-stearoyloxyethoxy)phenyl]benzofuran-2-one, 3,3′-bis[5,7-di-tert-butyl-3-(4-(2-hydroxyethoxy]phenyl)benzofuran-2-one), 5,7-di-tert-butyl-3-(4-ethoxyphenyl)benzofuran-2-one, 3-(4-acetoxy-3,5-dimethylphenyl)-5,7-di-tert-butyl-benzofuran-2-one, β-(3,5-dimethyl-4-pivaloyloxyphenyl)-5,7-di-tert-butyl-benzofuran-2-one, 3-(3,4-dimethylphenyl)-5,7-di-tert-butyl-benzofuran-2-one, 3-(2,3-dimethylphenyl)-5,7-di-tert-butyl-benzofuran-2-one as well as lactones that additionally contain phosphite groups such as

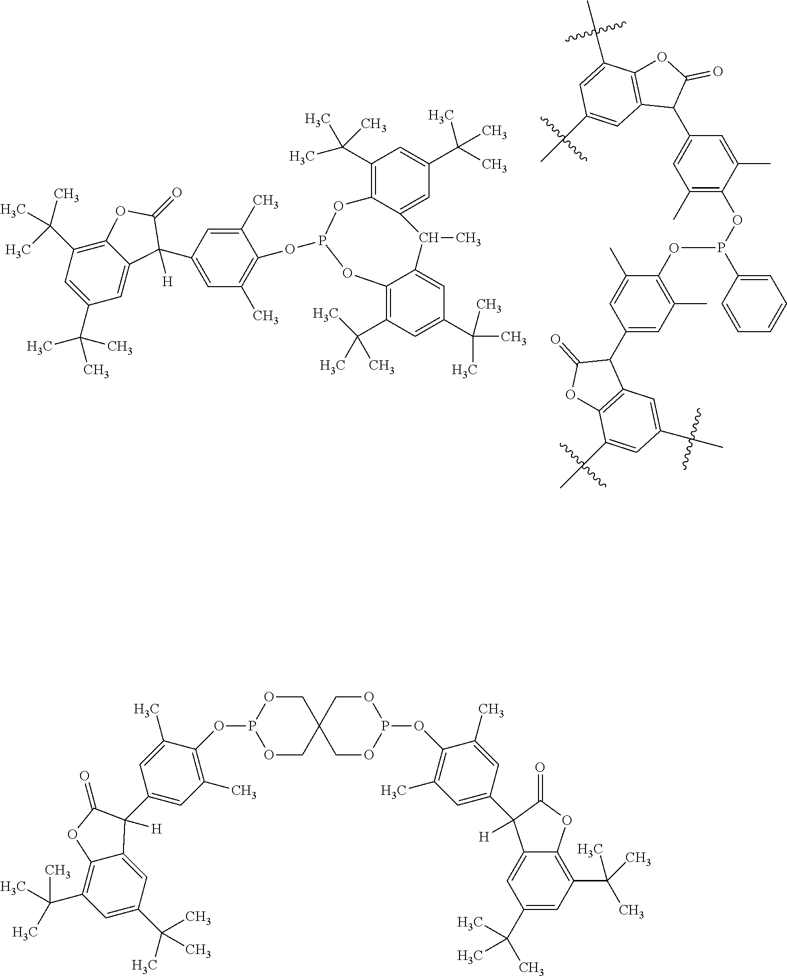

A particularly preferred lactone has the following structure:

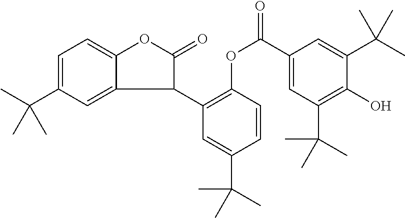 [SMILES: CC(C)(C)c1ccc(OC(=O)c2cc(C(C)(C)C)c(O)c(C(C)(C)C)c2)c(C2C(=O)Oc3ccc(C(C)(C)C)cc32)c1]

A further suitable group of antioxidants are isoindolol[2,1-A]quinazolines, such as

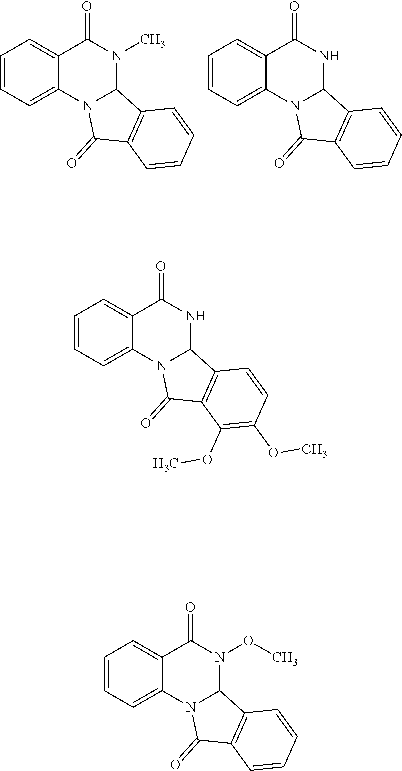

Preferably, the at least one secondary antioxidant is selected from the group consisting of phosphites, phosphonites, organo-sulphur compounds such as sulphides and disulphides, and mixtures and combinations thereof.

Secondary antioxidants primarily act as hydroperoxide decomposers in the stabilization of plastics.

Suitable secondary antioxidants are in particular phosphites or phosphonites such as triphenylphosphite, diphenylalkylphosphites, phenyldialkylphosphites, tri(nonylphenyl)phosphite, trilaurylphosphites, trioctadecylphosphite, distearylpentaerythritol diphosphite, tris-(2,4-di-tert-butylphenyl)phosphite, diisodecylpentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl)-4,4′-biphenylenediphosphonite, 6-isooctyloxy-2,4,8,10-tetra-tert-butyl-12H-dibenz[d,g]-1,3,2-dioxaphosphocine, bis(2,4-di-tert-butyl-6-methylphenyl)methylphosphite, bis(2,4-di-tert-butyl-6-methylphenyl)ethylphosphite, 6-fluoro-2,4,8,10-tetra-tert-butyl-12-methyl-dibenz[d,g]-1.3,2-dioxaphosphocine. 2,2′2″-nitrilo[triethyltris(3,3″,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl))phosphite, 5-butyl-5-ethyl-2-(2,4,6-tri-tert-butylphenoxy)-1,3,2-dioxaphosphirane.

Particularly preferred phosphites are:

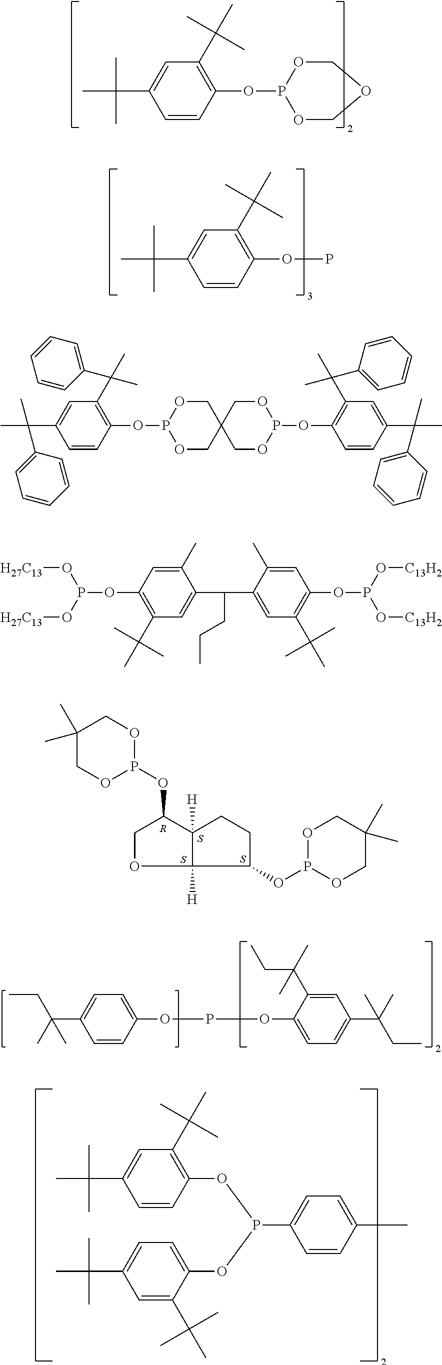

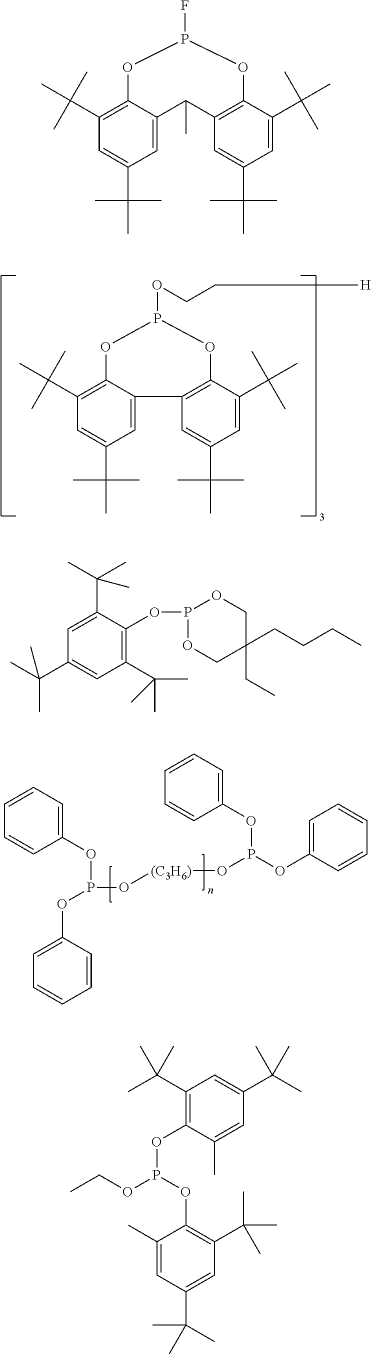

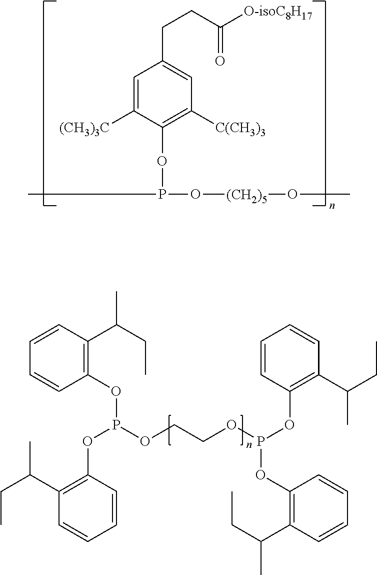

with n=3-100

A preferred phosphonite is:

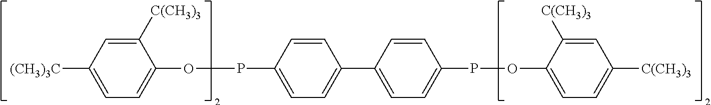

s Suitable secondary antioxidants are furthermore organosulphur compounds such as sulphides and disulphides, e.g., distearylthiodipropionate, dilaurylthiodipropionate; ditridecyldithiopropionate, ditetradecylthiodipropionate, 3-(dodecylthio)-,1,1′-[2,2-bis[[3-(dodecylthio)-1-oxopropoxy]methyl]-1,3-propandiyl] propanoic acid ester. Preferred are the following structures:

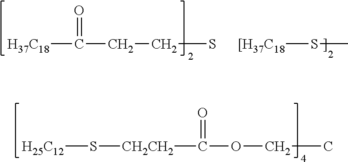

A preferred embodiment provides that the thermoplastic recyclate is selected from the group consisting of
a) recycled polymers of olefins or diolefins, such as polyethylene (LDPE, LLDPE, VLDPE, ULDPE, MDPE, HDPE, UHMWPE), metallocene-PE (m-PE), polypropylene, polyisobutylene, poly-4-methyl-pentene-1, polybutadiene, polyisoprene, such as natural rubber (NR), polycyclooctene, polyalkylene-carbon monoxide copolymers, as well as copolymers in the form of random or block structures, such as polypropylene-polyethylene (EP), EPM or EPDM with, for example, 5-ethylidene-2-norbornene as comonomer, ethylene-vinyl acetate (EVA), ethylene acrylic ester, such as ethylene-butyl acrylate, ethylene-acrylic acid and their salts (ionomers), as well as terpolymers such as ethylene-acrylic acid-glycidyl (meth)acrylate, graft polymers such as polypropylene-graft-maleic anhydride, polypropylene-graft-acrylic acid, polyethylene-graft-acrylic acid, polyethylene-polybutyl acrylate-graft-maleic anhydride as well as blends such as LDPE/LLDPE or also long-chain branched is polypropylene copolymers produced with alpha-olefins as comonomers, for example with 1-butene, 1-hexene, 1-octene or 1-octadecene,
b) recycled polystyrene, polymethylstyrene, poly-alpha-methylstyrene, polyvinylnaphthalene, polyvinylbiphenyl, polyvinyltoluene, styrene-butadiene (SB), styrene-butadiene-styrene (SBS), styrene-ethylene-butylene-styrene (SEBS), styrene-ethylene-propylene-styrene, styrene isoprene, styrene-isoprene-styrene (SIS), styrene-butadiene-acrylonitrile (ABS), styrene-acrylonitrile (SAN), styrene-acrylonitrile-acrylate (ASA), styrene-ethylene, styrene-maleic anhydride polymers including corresponding graft copolymers such as styrene on butadiene, maleic anhydride on SBS or SEBS, as well as graft copolymers of methyl methacrylate, styrene butadiene and ABS (MABS), as well as hydrogenated polystyrene derivatives such as polyvinylcyclohexane,
c) recycled polymers of unsaturated esters such as polyacrylates and polymethacrylates such as polymethyl methacrylate (PMMA), polybutyl acrylate, polylauryl acrylate; polystearyl acrylate; polyglycidyl acrylate, polyglycidyl methacrylate, polyacrylonitrile, polyacrylamides, copolymers such as polyacrylonitrile-polyalkyl acrylate,
d) recycled polymers of unsaturated alcohols and derivatives, such as polyvinyl alcohol, polyvinyl acetate, polyvinyl butyral, polyallyl phthalate, polyallyl melamine,
e) recycled polyacetals, such as polyoxymethylene (POM) or copolymers with, for example, butanal, polyphenylene oxides and blends with polystyrene or polyamides,
f) recycled polymers of cyclic ethers, such as polyethylene glycol, polypropylene glycol, polyethylene oxide, polypropylene oxide, polytetrahydrofuran,
g) recycled polyphenylene oxides and blends thereof with polystyrene and/or polyamides,
h) recycled thermoplastic polyurethanes (TPU), from hydroxy-terminated polyethers or polyesters and aromatic or aliphatic isocyanates, such as 2,4- or 2,6-toluene diisocyanate or methylene diphenyl diisocyanate, polyureas,
i) recycled polyamides such as polyamide-6, 6.6, 6.10, 4.6, 4.10, 6.12, 10.10, 10.12, is 12.12, polyamide 11, polyamide 12 as well as (semi-)aromatic polyamides, such as polyphthalamides, for example produced from terephthalic acid and/or isophthalic acid and aliphatic diamines, such as hexamethylenediamine or m-xylylenediamine or from aliphatic dicarboxylic acids such as adipic acid or sebacic acid and aromatic diamines such as 1,4- or 1,3-diaminobenzene, blends of different polyamides such as PA-6 and PA 6.6 or blends of polyamides and polyolefins such as PA/PP,
j) recycled polyimides, polyamideimides, polyetherimides, polyesterimides, poly(ether)ketones, polysulfones, polyethersulfones, polyarylsulfones, polyphenylene sulphides, polybenzimidazoles, polyhydantoins,
k) recycled polyesters of aliphatic or aromatic dicarboxylic acids and diols or of hydroxy-carboxylic acids, such as polyethylene terephthalate (PET), polybutylene terephthalate (PBT), polypropylene terephthalate (PPT), polyethylene naphthylate (PEN), poly-1,4-dimethylolcyclohexane terephthalate, polyhydroxybenzoate, polyhydroxynaphthalate, preferably recycled aliphatic polyesters, polylactic acid (PLA), polyhydroxybutyrate (PHB), polyhydroxyvalerate (PHV), polybutylene succinate (PBS), poly(butylene succinate-co-adipate) (PBSA), polyethylene succinate, polytetramethylene succinate, polycaprolactone,
l) recycled polycarbonates, polyester carbonates, as well as blends such as PC/ABS, PC/PBT, PC/PET/PBT, PC/PA,
m) recycled cellulose derivatives such as cellulose nitrate, cellulose acetate, cellulose propionate, cellulose butyrate,
n) recycled linear polyethers from epoxides, for example from diglycidyl ethers and dicarboxylic acids or by anionic ring-opening polymerization of epoxides
o) and mixtures, combinations or blends of two or more of the aforementioned polymers.

Particularly preferably, the thermoplastic recyclate is selected from the group consisting of polymers of olefins or diolefins, such as polyethylene, in particular LDPE, LLDPE, VLDPE, ULDPE, MDPE, HDPE and UHMWPE, metallocene-PE (m-PE), polypropylene, is polyisobutylene, poly-4-methyl-pentene-1, polybutadiene, polyisoprene, polycyclooctene, polyalkylene-carbon monoxide copolymers, as well as corresponding copolymers in the form of random or block structures, such as polypropylene-polyethylene (EP), EPM or EPDM, ethylene-vinyl acetate (EVA), ethylene-acrylic esters such as ethylene-butyl acrylate, ethylene-acrylic acid-glycidyl acrylate, and corresponding graft polymers, such as polypropylene-g-maleic anhydride, polypropylene-g-acrylic acid and polyethylene-g-acrylic acid.

Very particularly preferably, the one thermoplastic is a polyolefin recyclate. For example, the thermoplastic recyclate may be polypropylene, in particular a polypropylene recyclate homopolymer or copolymer, or polyethylene, in particular a polyethylene recyclate, for example HDPE, LDPE, LLDPE, MDPE, VLDPE or mixtures thereof. For example, polyethylene films from collections of recyclable materials often consist of a mixture of LDPE and LLDPE or of LDPE, LLDPE and HDPE film types. PP from collections of recyclable materials often contains mixtures of PP homo- and copolymers, which may contain up to 20% polyethylene.

Another particularly preferred group are recyclates of aliphatic polyesters from renewable raw materials, which are produced substantially from aliphatic dicarboxylic acids and aliphatic diols, from hydroxycarboxylic acids or lactones, such as polylactic acid (PLA), polyglycolic acid (PGA), polyhydroxybutyric acid (PHB), polyhydroxyvaleric acid (PHV), polyethylene succinate (PESu), polybutylene succinate (PBS), polyethylene adipate, poly(butylene succinate-co-adipate) (PBSA) or polycaprolactone (PCL).

In addition, the compositions may contain other additives selected from the group consisting of UV absorbers, light stabilizers, in particular the hindered amines as light (HALS) and long-term heat stabilizers (HAS), metal deactivators, filler deactivators, antiozonants, nucleating agents, antinucleating agents, transparency improvers (clarifiers), impact modifiers, plasticizers, lubricants, rheology modifiers, thixotropic agents, chain extenders, processing aids, demoulding aids, flame retardants, pigments, dyes, optical brighteners, antimicrobial agents, antistatic agents, slip agents, antiblocking agents, coupling agents, crosslinking agents, anti-crosslinking agents, hydrophilizing agents, hydrophobicizing agents, is surface modifiers, hydrolysis stabilizers, adhesion promoters, dispersing agents, compatibilizers, oxygen scavengers, acid scavengers, acetaldehyde and formaldehyde scavengers, blowing agents, degradation additives, defoaming agents, odour scavengers, odour-improving substances, PVC heat stabilizers, marking agents, antifogging agents, gloss improvers, mattifying agents, additives for increasing the electrica; and/or thermal conductivity, repellants, fillers and reinforcing agents are used.

In a preferred embodiment the recyclate compositions contain in particular hindered amines as light and long-term heat stabilizers, fillers, acid scavengers, polyol co-stabilizers or compatibilizers.

Suitable fillers and reinforcing materials are, for example, synthetic or natural materials such as calcium carbonate, silicates, glass fibres, glass balls (solid or hollow), talc, mica, kaolin, barium sulfate, metal oxides and metal hydroxides, carbon black, graphite, carbon nanotubes, graphene, wood flour or fibres of natural products such as cellulose or synthetic fibres. Other suitable fillers are hydrotalcites or zeolites or layered silicates such as montmorillonite, bentonite, beidelite, mica, hectorite, saponite, vermiculite, ledikite, magadite, illite, kaolinite, wollastonite, attapulgite.

Suitable acid scavengers (“antiacids”) are salts of monovalent, divalent, trivalent or tetravalent metals, preferably alkali metals, alkaline earth metals, aluminium or zinc, in particular formed with fatty acids, such as calcium stearate, magnesium stearate, zinc stearate, aluminium stearate, calcium laurate, calcium behenate, calcium lactate, calcium stearoyl-2-lactate. Other classes of suitable acid scavengers are hydrotalcites, in particular synthetic hydrotalcites based on aluminum, magnesium and zinc, hydrocalumites, zeolites, alkaline earth oxides, in particular calcium oxide and magnesium oxide as well as zinc oxide, alkaline earth carbonates, in particular calcium carbonate, magnesium carbonate and dolomite as well as hydroxides, in particular brucite (magnesium hydroxide).

Suitable costabilizers are also polyols, in particular alditols or cyclitols. Polyols are, for example, pentaerythritol, dipentaerythritol, tripentaerythritol, short chain polyether polyols or polyester polyols, as well as hyperbranched polymers/oligomers or dendrimers with alcohol groups, for example

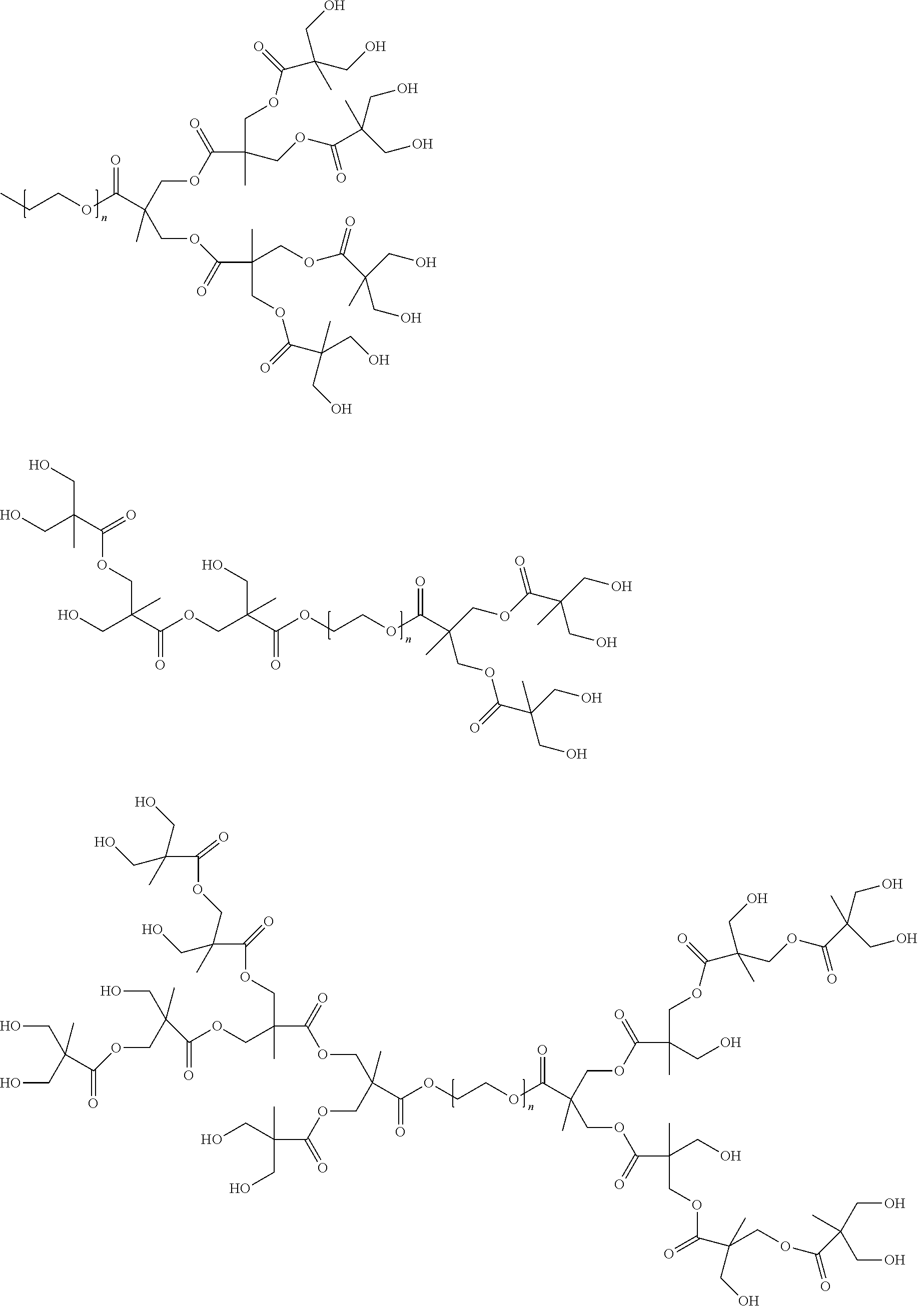

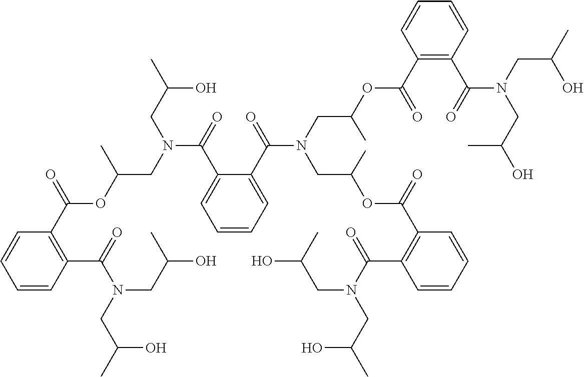 [SMILES: CC(O)CN(CC(C)O)C(=O)c1ccccc1C(=O)OC(C)CN(CC(C)O)C(=O)c1ccccc1C(=O)N(CC(C)OC(=O)c1ccccc1C(=O)N(CC(C)O)CC(C)O)CC(C)OC(=O)c1ccccc1C(=O)N(CC(C)O)CC(C)O]

Preferably, the at least one alditol is selected from the group consisting of threitol, erythritol, galactitol, mannitol, ribitol, sorbitol, xylitol, arabitol, isomalt, lactitol, maltitol, altritol, iditol, maltotritol, and hydrogenated oligo- and polysaccharides having polyol end groups, and mixtures thereof. Particularly preferred is the at least one preferred alditol selected from the group consisting of erythritol, mannitol, isomalt, maltitol and mixtures thereof.

Examples of other suitable sugar alcohols are heptitols and octitols: meso-glycero-allo heptitol, D-glycero-D-altro heptitol, D-glycero-D-manno heptitol, meso-glycero-gulo heptitol, D-glycero-D-galacto heptitol (perseitol), D-glycero-D-gluco heptitol, L-glycero-D-gluco heptitol, D-erythro-L-galacto-octitol, D-threo-L-galacto-octitol.

In particular, the at least one cyclitol may be selected from the group consisting of inositol (myo, scyllo-, D-chiro-, L-chiro-, muco-, neo-, allo-, epi- and cis-inositol). 1.2.3.4-tetrahydroxycyclohexane, 1,2,3,4,5-pentahydroxycyclohexane, quercitol, viscumitol, bornesitol, conduritol, ononitol, pinitol, pinpollitol, quebrachitol, ciceritol, quinic acid, shikimic acid and valienol; myo-inositol is preferred here.

Other suitable costabilizers are ester and ether derivatives of the stated alditols or cyclitols, such as the following compounds:

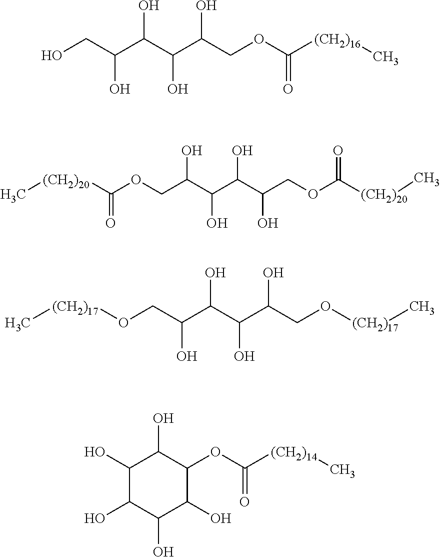

Suitable UV stabilizers are, for example, compounds based on 2-(2′-hydroxyphenyl)benzotriazoles, 2-hydroxybenzophenones, esters of benzoic acids, acrylates, oxamides and 2-(2-hydroxyphenyl)-1,3,5-triazines.

Suitable 2-(2′-hydroxyphenyl)benzotriazoles are, for example, 2-(2′-hydroxy-5′methylphenyl)benzotriazole, 2-(3′,5′-di-tert-butyl-2′-hydroxyphenyl)benzotriazole, 2-(5′-tert-butyl-2′-hydroxy-phenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl-5-chlorobenzotriazole, 2-(3′-sec-butyl-5′-tert-butyl-2′-hydroxy-phenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazol-2-ylphenol]; the product of the transesterification of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂—]-₂, where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)phenyl]benzotriazole-2-[2′-hydroxy-3′-(1,1,3,3-tetramethylbutyl)-5′-(α,α-dimethylbenzyl)phenyl]benzotriazole.

Suitable 2-hydroxybenzophenones are, for example, 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethyoxy derivatives of 2-hydroxybenzophenones.

Suitable acrylates are, for example, ethyl-α-cyano-β,β-diphenyl acrylate, isooctyl-α-cyano-β,β-diphenyl acrylate, methyl-α-carbomethoxycinnamate, methyl-α-cyano-β-methyl-p-methoxycinnamate, butyl-α-cyano-β-methyl-p-methoxycinnamate, methyl-α-carbomethoxy-p-methoxycinnamate and N-(β-carbomethoxy-β-cyanovinyl)-2-methylindoline.

Suitable esters of benzoic acids are, for example, 4-tert-butylphenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl-3,5-di-tert-butyl-4-hydroxybenzoate, hexadecyl-3,5-di-tert-butyl-4-hydroxybenzoate, octadecyl-3,5-di-tert-butyl-4-hydroxybenzoate, 2-methyl-4,6-di-tert-butylphenyl-3,5-di-tert-butyl-4-hydroxybenzoate.

Suitable oxamides are, for example, 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and mixtures thereof with 2-ethoxy-2′-ethyl-5,4′-di-tert-butoxanilide, mixtures of o- and p-methoxy-disubstituted oxanilides and mixtures of o- and p-ethoxy-disubstituted oxanilides.

Suitable 2-(2-hydroxyphenyl)-1,3,5-triazines are, for example, 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)-phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl-1,3,5-triazine.

Suitable hindered amines are, for example, 1,1-bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl)-n-butyl-3,5-di-tert-butyl-4-hydroxybenzylmalonate, the condensation product of 1-(2-hydroxyethyl)-2,2,6,6-tetramethyl-4-hydroxypiperidine and succinic acid, linear or cyclic condensation products of N,N′-bis(2,2,6,6-tetramethyl-4-piperidyl)hexamethylene diamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, linear or cyclic condensation products of N,N′-bis(2,2,6,6-tetramethyl-4-piperidyl)hexamethylene diamine and 4-morpholino-2,6-dichloro-1,3,5-triazine, the reaction product of 7,7,9,9-tetramethyl-2-cycloundecyl-1-oxa-3,8-diaza-4-oxospiro-[4,5]decane and epichlorohydrin. The above-mentioned structures also include, in each case, the sterically hindered N—H, N-alkyl, such as N-methyl or N-octyl, the N-alkoxy derivatives, such as N-methoxy or N-octyloxy, the cycloalkyl derivatives, such as N-cyclohexyloxy and the N-(2-hydroxy-2-methylpropoxy) analogues. The above-mentioned structures also include, in each case, the sterically hindered N—H, N-alkyl, such as N-methyl or N-octyl, the N-alkoxy derivatives, such as N-methoxy or N-octyloxy, the cycloalkyl derivatives, such as N-cyclohexyloxy and the N-(2-hydroxy-2-methylpropoxy) analogues.

Preferred hindered amines furthermore have the following structures:

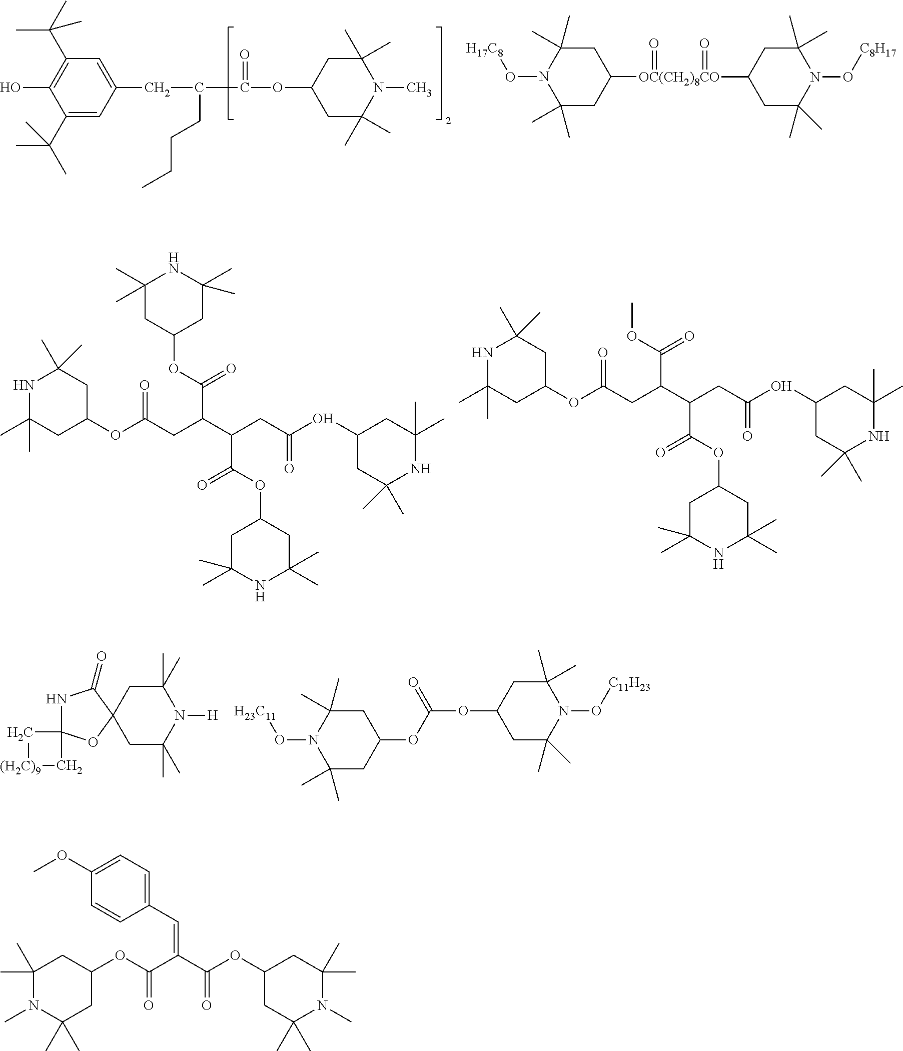

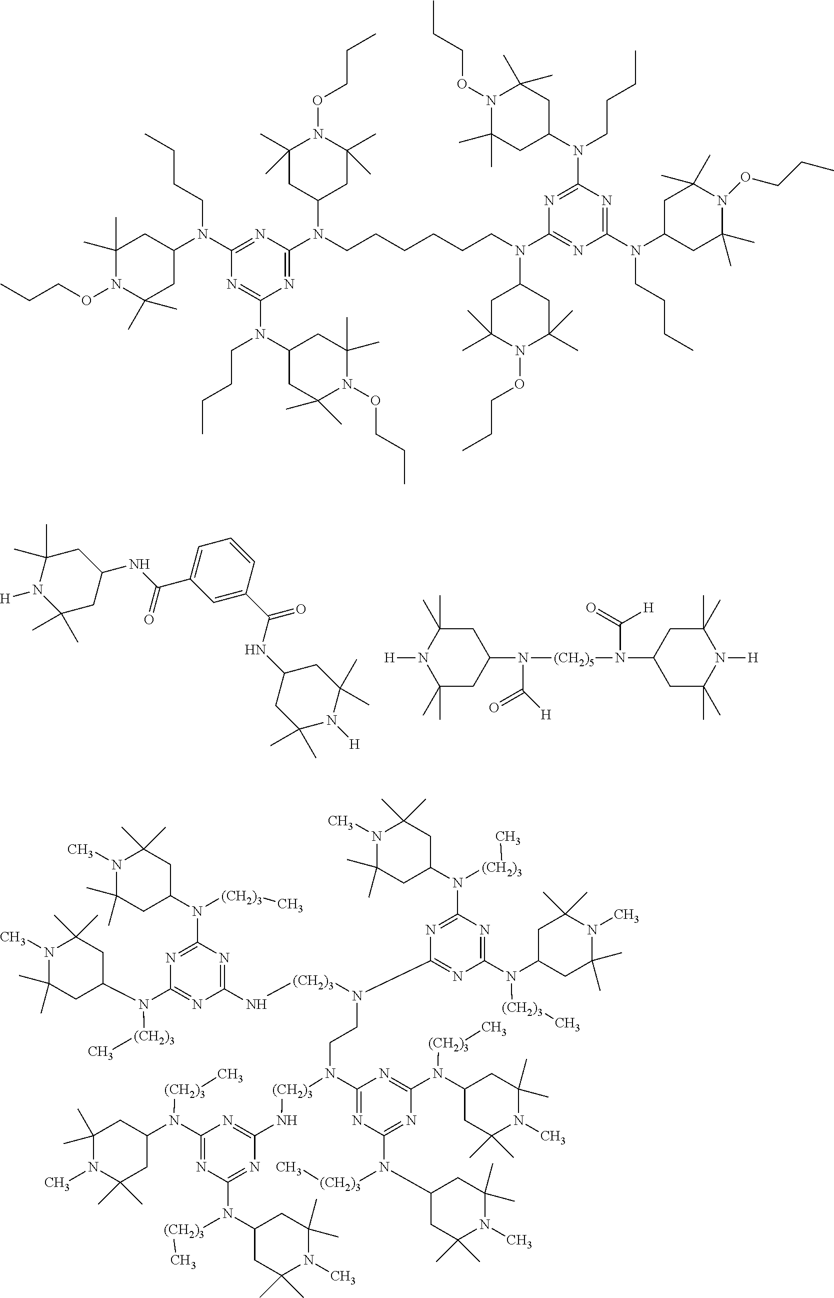

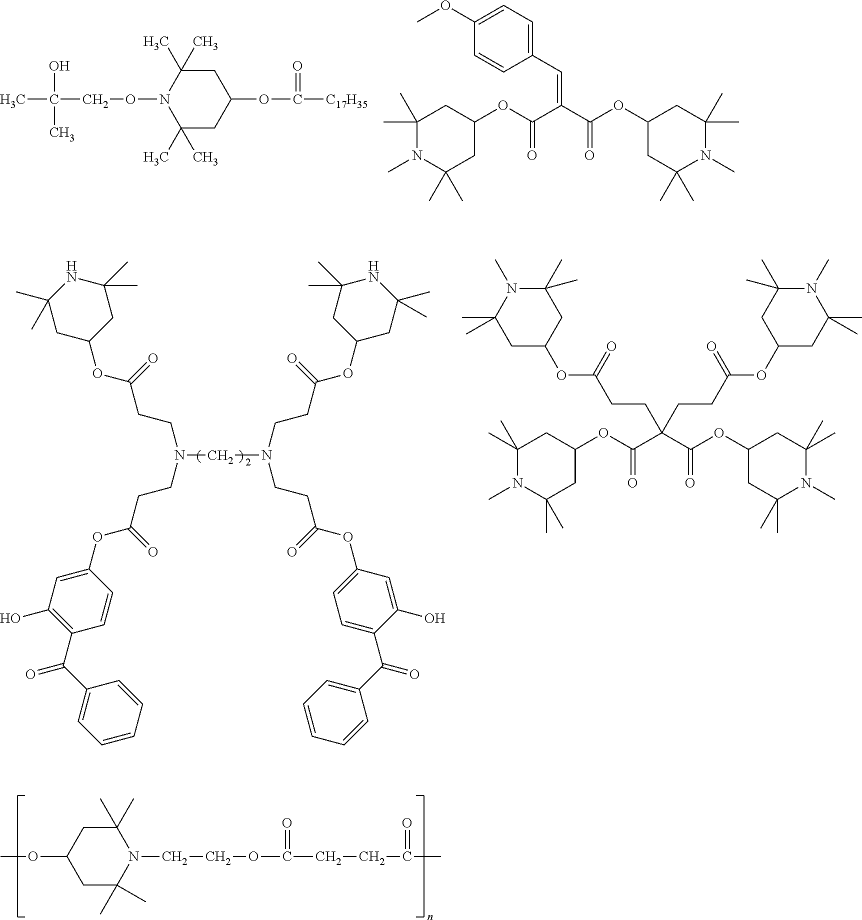

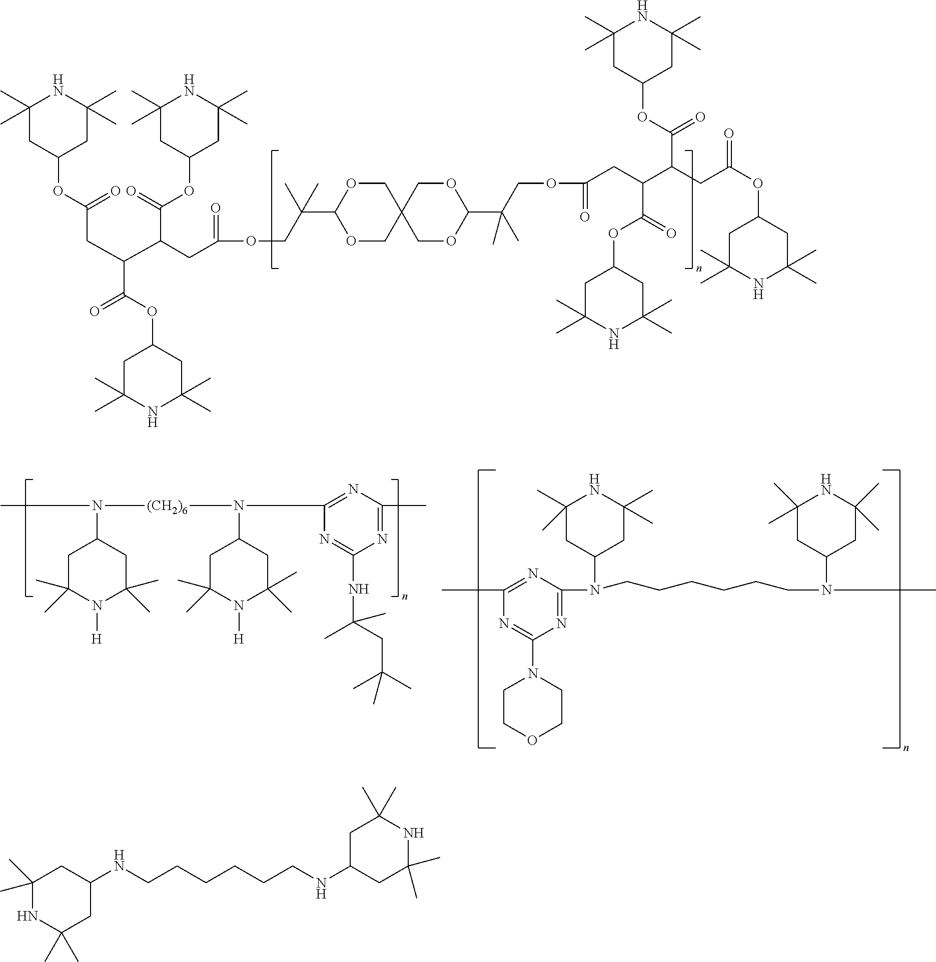

Preferred oligomeric and polymeric hindered amines have the following structures:

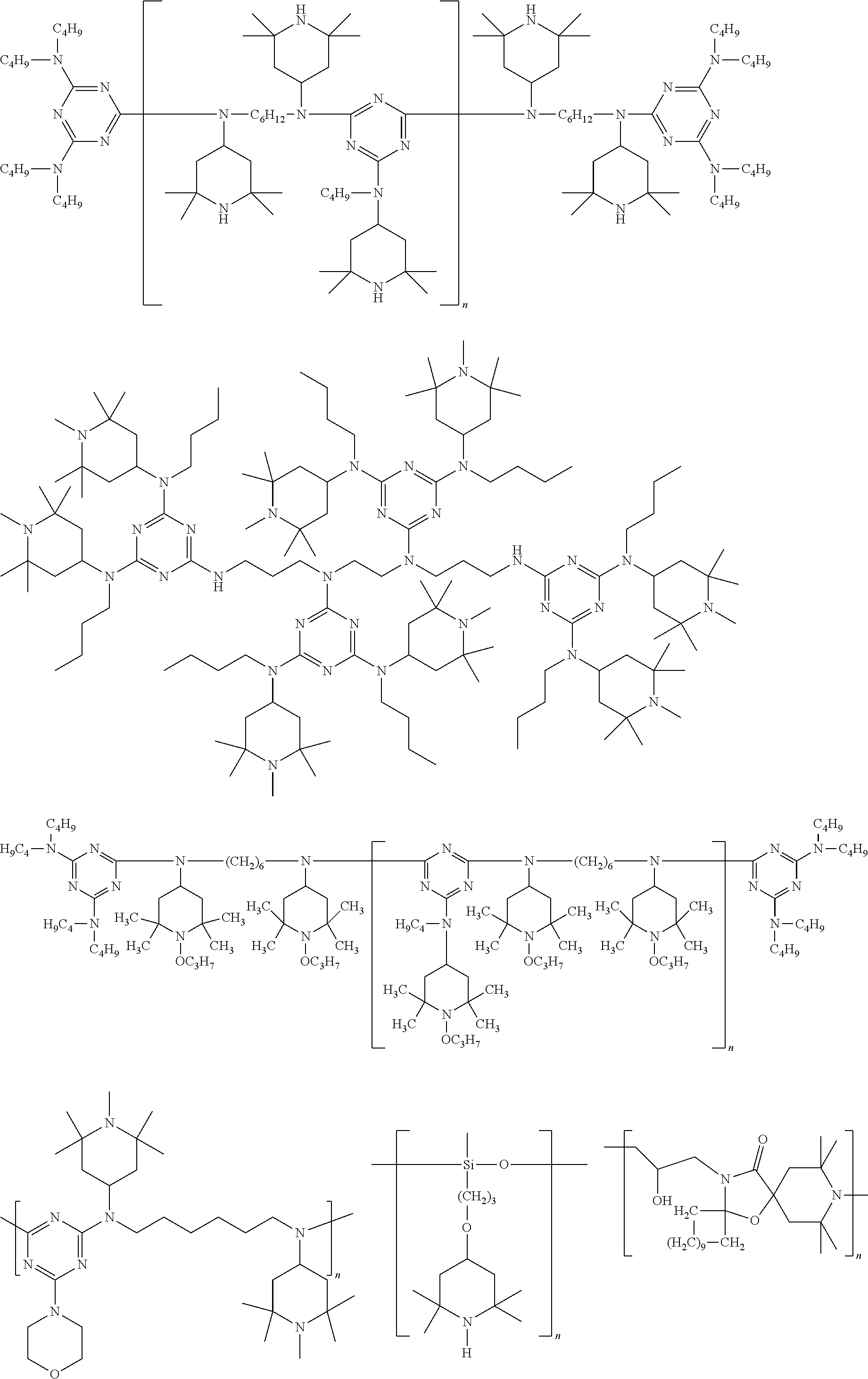

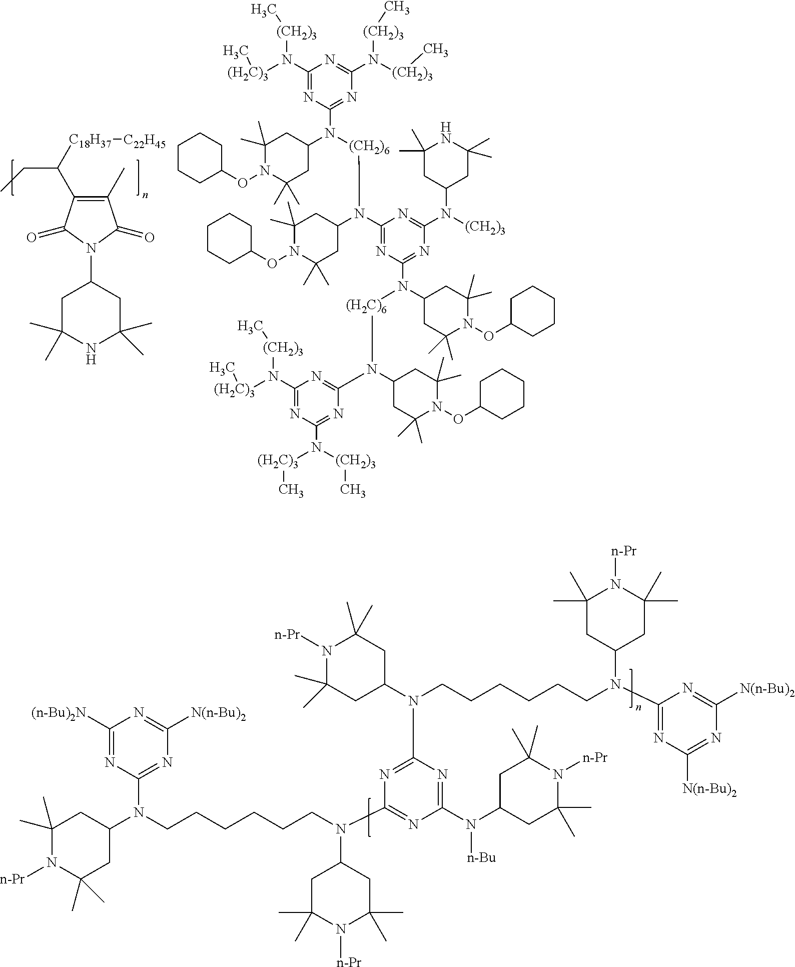

Another suitable light stabilizer is Hostanox NOW (manufacturer: Clariant SE) with the following general structure:

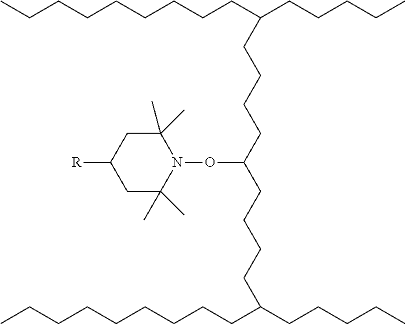

wherein R means —O—C(O)—C₁₅H₃₁ or —O—C(O)—C₁₇H₃₅.

Compatibilizers are used, for example, in thermodynamically immiscible blends or also in recyclate mixtures and contain structural elements of the respective blend components that are mixed. Suitable compatibilizers for polyolefin mixtures are, for example, olefin block copolymers, consisting of ethylene, propylene and alpha-olefins such as 1-octene. Other compatibilizers, in particular for compatibilizing polar polymers such as PET or polyamides and non-polar polymers such as PP or PE, often contain reactive groups derived, for example, from maleic anhydride, acrylic acid, glycidyl acrylate or glycidyl methacrylate and are, for example, polypropylene-g-maleic anhydride, polyethylene-g-maleic anhydride, polypropylene-g-acrylic acid, polyethylene-g-acrylic acid, poly(ethylene-co-maleic anhydride),

SBS-g maleic anhydride SEBS-g maleic anhydride, polyethylene polyacrylate polyglycidyl methacrylate

Suitable dispersants are, for example:

Polyacrylates, for example copolymers with long-chain side groups, polyacrylate block copolymers, alkylamides: for example N,N′-1,2-ethanediylbisoctadecanamide sorbitan esters, for example monostearyl sorbitan esters, titanates and zirconates, reactive copolymers with functional groups, for example polypropylene-co-acrylic acid, polypropylene-co-maleic anhydride, polyethylene-co-glycidyl methacrylate, polystyrene-alt-maleic anhydride polysiloxanes: for example dimethylsilanediol-ethylene oxide copolymer, polyphenylsiloxane copolymer, amphiphilic copolymers: for example polyethylene-block-polyethylene oxide, dendrimers, for example dendrimers containing hydroxyl groups.

Suitable flame retardants are, in particular
a) inorganic flame retardants, such as Al(OH)₃, Mg(OH)₂, AlO(OH), MgCO₃, layered silicates, such as montmorillonite or sepiolite, unmodified or organically modified, double salts, such as Mg—Al-silicates, POSS (Polyhedral Oligomeric Silsesquioxane) compounds, huntite, hydromagnesite or halloysite as well as Sb₂O₃, Sb₂O₅, MoO₃, zinc stannate, zinc hydroxystannate,
b) nitrogenous flame retardants such as melamine, melem, melam, melon, melamine derivatives, melamine condensation products or melamine salts, benzoguanamine, polyisocyanurates, allantoin, phosphacenes, in particular melamine cyanurate, melamine phosphate, dimelamine phosphate, melamine pyrophosphate, melamine polyphosphate, melamine metal phosphates such as melamine aluminum phosphate, melamine zinc phosphate, melamine magnesium phosphate, and the corresponding pyrophosphates and polyphosphates, poly-[2,4-(piperazin-1,4-yl)-6-(morpholin-4-yl)-1,3,5-triazine], ammonium polyphosphate, melamine borate, is melamine hydrobromide,
c) radical formers, such as alkoxyamines, hydroxylamine esters, azo compounds, sulfenamides, sulfenimides, dicumyl or polycumyl, hydroxyimides and their derivatives, such as hydroxyimide esters or hydroxyimide ethers
d) phosphorus-containing flame retardants, such as red phosphorus, phosphates, such as resorcinol diphosphate, bisphenol A diphosphate and its oligomers, triphenyl phosphate, ethylenediamine diphosphate, phosphinates, such as salts of hypophosphorous acid and their derivatives, such as alkyl phosphinate salts, for example diethyl phosphinate aluminium or diethyl phosphinate zinc or aluminium phosphinate, aluminium phosphite, aluminium phosphonate, phosphonate esters, oligomeric and polymeric derivatives of methane phosphonic acid, 9,10-dihydro-9-oxa-10-phosphorylphenanthrene-10-oxide (DOPO) and substituted compounds thereof,
e) halogen-containing chlorine- and bromine-based flame retardants, such as polybrominated diphenyl oxides, such as decabromodiphenyloxide,tris(3-bromo-2,2-bis(bromomethyl)propyl-phosphate, tris(tribromneopentyl)phosphate, tetrabromophthalic acid, 1,2-bis(tribromophenoxy)ethane, hexabromocyclododecane, brominated diphenylethane, tris-(2,3-dibromopropyl)isocyanurate, ethylene-bis(tetrabromophthalimide), tetrabromo-bisphenol A, brominated polystyrene, brominated polybutadiene or polystyrene-brominated polybutadiene copolymers, brominated polyphenylene ether, brominated epoxy resin, polypentabromobenzyl acrylate, optionally in combination with Sb₂O₃ and/or Sb₂05,
f) borates, such as zinc borate or calcium borate, optionally on a carrier material such as silica
g) sulphur-containing compounds, such as elemental sulphur, disulphides and polysulphides, thiuram sulphide, dithiocarbamates, mercaptobenzthiazole and sulfenamides,
h) anti-drip agents, such as polytetrafluoroethylene,
i) silicon-containing compounds, such as polyphenylsiloxanes,
j) carbon modifications, such as carbon nanotubes (CNT), expanded graphite or graphene
k) and combinations or mixtures thereof.

Particularly suitable flame retardants are:
radical formers preferably selected from the group consisting of N-alkoxyamines, —C—C— radical formers, radical formers with azo groups (—N═N—), radical formers with hydrazine groups (—NH—HN—), radical formers with hydrazone groups (>C═N—NH—), radical formers with azine groups (>C═N—N═C<), radical formers with triazene groups (—N═N—N<) or from iminoxytriazines.

The preparation of suitable azo compounds is described, for example, in M. Aubert et. al. Macromol. Sci. Eng. 2007, 292, 707-714 or in WO 2008101845, the preparation of hydrazones and azines is described in M. Aubert et al., Pol. Adv. Technol. 2011, 22, 1529-1538, the preparation of triazenes is described in W. Pawelec et al., Pol. Degr. Stab. 2012, 97, 948-954. The synthesis of iminoxytriazines is described in WO 2014/064064.

Radical formers to be used in particular are selected here from the group consisting of
a) N-alkoxyamines according to the structural formula shown below

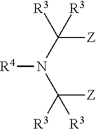

wherein
R³ represents hydrogen or an optionally substituted alkyl, cycloalkyl, aryl-heteroaryl or acyl group, in particular a C1 to C4 alkyl group,
R⁴ represents an alkoxy, aryloxy, cycloalkoxy, aralkoxy or acyloxy group,
Z represents hydrogen or an optionally substituted alkyl, cycloalkyl, aryl-heteroaryl or acyl group, wherein the two groups Z may also form a closed ring, which may optionally be substituted by ester, ether, amine, amide, carboxy or urethane groups,
E represents an alkoxy, aryloxy, cycloalkyloxy, aralkoxy or acyloxy group,
b) azo compounds according to the structural formulas shown below

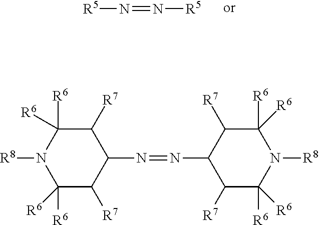

wherein
R⁵ means an alkyl, cycloalkyl or aryl group,
R⁶ is the same or different at each occurrence and means a linear or branched alkyl group,
R⁷ is the same or different at each occurrence and means hydrogen or a linear or branched alkyl group, and
R⁸ is the same or different at each occurrence and is an alkyl, alkoxy, aryloxy-cycloalkyloxy, aralkoxy or acyloxy group,
c) dicumyl according to the structural formula shown below

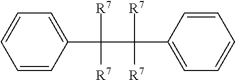

wherein R⁷ has the meaning given above, is preferably methyl,
d) and/or polycumyl according to the structural formula shown below

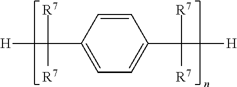

wherein R⁷ has the meaning given above, is preferably methyl, and 2<n<100.

Typical examples of the aforementioned N-alkoxyamines of the indicated structure are:
1-cyclohexyloxy-2,2,6,6-tetramethyl-4-octadecylaminopiperidine: bis(1-octyloxy-2,2,6,6-tetramethylpiperidin-4-yl) sebacate; 2,4-bis[(1-cyclohexyloxy-2,2,6,6-tetramethylpiperidin-4-yl)butylamino]-6-(2-hydroxyethylamino-S-triazine; bis(1-cyclohexyloxy-2,2,6,6-tetramethylpiperidin-4-yl) adipate;
2,4-bis[(1-cyclohexyloxy-2,2,6,6-tetramethylpiperidin-4-yl)butylamino]-6-chloro-S-triazine; 1-(2-hydroxy-2-methylpropoxy)-4-hydroxy-2,2,6,6-tetramethylpiperidine; 1-(2-hydroxy-2-methylpropoxy)-4-oxo-2,2,6,6-tetramethylpiperidine; 1-(2-hydroxy-2-methylpropoxy)-4-octadecanoyloxy-2,2,6,6-tetramethylpiperidine; bis(1-(2-hydroxy-2-methylpropoxy)-2,2,6,6-tetramethylpiperidin-4yl)sebacate; bis(1-(2-hydroxy-2-methylpropoxy)-2,2,6,6-tetramethylpiperidin4-yl)adipate; 2,4-bis{N-[1-(2-hydroxy-2-methylpropoxy)-2,2,6,6-tetramethylpiperidin-4-yl]-N-butylamino}-6-(2-hydroxyethylamino)-S-triazine); 4-piperidinol, 2,2,6,6-tetramethyl-1-(undecyloxy)-4,4′-carbonate; the reaction product of 2,4-bis[(1-cyclohexyloxy-2,2,6,6-tetramethylpiperidin-4-yl)butylamino]-6-chloro-S-triazine with N,N′-bis(3-aminopropylethylenediamine); the oligomer compound which is the condensation product of 4,4′-hexamethylene-bis(amino-2,2,6,6-tetramethylpiperidine) and 2,4-dichloro-6-[(1-cyclohexyloxy-2,2,6,6-tetramethyl-4-yl)butylamino]-S-triazine, terminated at the ends by 2-chloro-4,6-bis(dibutylamino)-S-triazine; aliphatic hydroxylamine, such as disterarylhydroxylamine; and compounds of the following formulas.

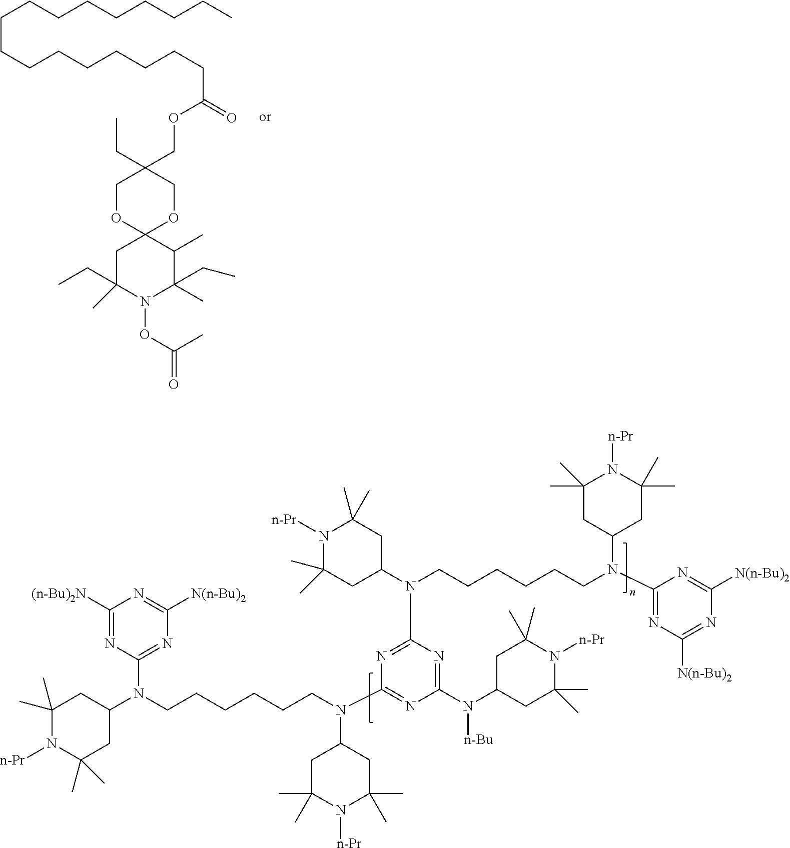

wherein n=1-15.

The above-stated compounds are partly commercial products and are traded under the following trade names: FLAMESTAB NOR 116®, TINUVIN NOR 371®, IRGATEC CR 76 ® from BASF SE, Hostavin NOW® from Clariant or ADK Stab LA 81 ® from Adeka. Dicumyl and polycumyl are commercial products available, for example, from United Initiators.
a) Phosphorus-containing flame retardants, e.g., phosphinates of the following structures:

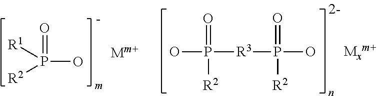

wherein preferably R1 and R2 are identical or different and are selected from linear or branched C1-C6 alkyl and/or aryl; M is selected from the group consisting of Mg, Ca, Al, Sb, Sn, Ge, Ti, Fe, Zr, Ce, Bi, Sr, Mn, Li, Na, K, Zn and/or a protonated nitrogen base, preferably calcium ions, magnesium ions, aluminium ions, and/or zinc ions; and m=1-4, preferably 2 or 3; n=1-4, preferably 1 or 3; x=1-4, preferably 1 or 2. In a particularly preferred embodiment, R₁=alkyl, R₂=alkyl and M=Al or Zn.

A particularly preferred example of a phosphinate is constituted by the commercially is available products Exolit OP® from Clariant SE.

Further preferred phosphorus-containing flame retardants are metal salts of hypophosphorous acid having a structure according to the formula

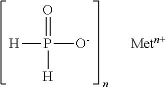

wherein Met is a metal selected from groups I, II, III and IV of the Periodic Table of the Elements, and n is a number from 1 to 4 corresponding to the charge of the corresponding metal ion Met. Metⁿ⁺ is for example Na⁺, Ca²⁺, Mg²⁺, Zn²⁺, Ti⁴⁺ or Al³⁺, wherein Ca²⁺, Zn²⁺ and Al³⁺ are particularly preferred.

Some of the above-mentioned salts of hypophosphorous acid are commercially available, e.g., under the name Phoslite® from Italmatch Chemicals.

Another preferred group of phosphorus-containing flame retardants are phosphonates or diaryl phosphonic acid esters of a structure according to the following formula:

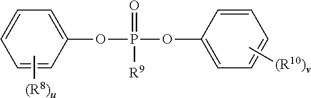

where R₈ and R₁₀═H, alkyl, preferably C1-C4, R₉═C1-C4 alkyl, u=1-5 and v=1-5.

Corresponding structures may also be in the form of phosphonate oligomers, polymers and co-polymers. Linear or branched phosphonate oligomers and polymers are known from the prior art. For branched phosphonate oligomers and polymers, reference is made to US patents U.S. Pat. Nos. 2,716,101, 3,326,852, 4,328,174, 4,331,614, 4,374,971, 4,415,719, 5,216,113, 5,334,692, 3,442,854, 6,291,630 B1, 6,861,499 B2 and 7,816,486 B2. For phosphonate oligomers, reference is made to US patent applications US 2005/0020800 A1, US 2007/0219295 A1 and US 2008/0045673 A1. With regard to linear phosphonate oligomers and polymers, reference is made to U.S. Pat. Nos. 3,946,093, 3,919,363, 6,288,210B1, 2,682,522 and 2,891,915.

Phophonates are available, for example, under the trade name Nofia® from FRX Polymers.

Another preferred group of phosphorus-containing flame retardants are compounds based on oxaphosphorine oxide and their derivatives with, for example, the following structures:

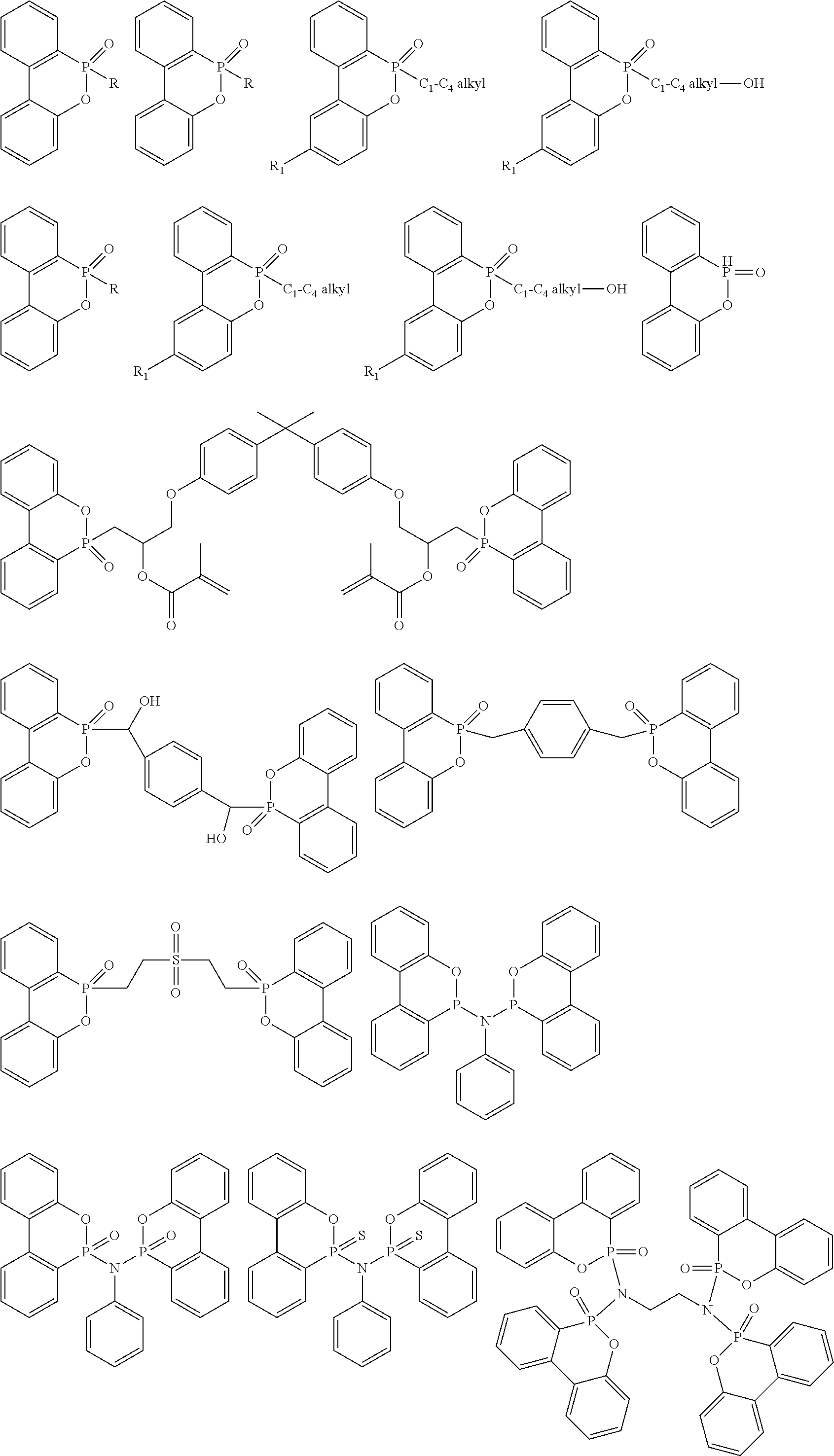

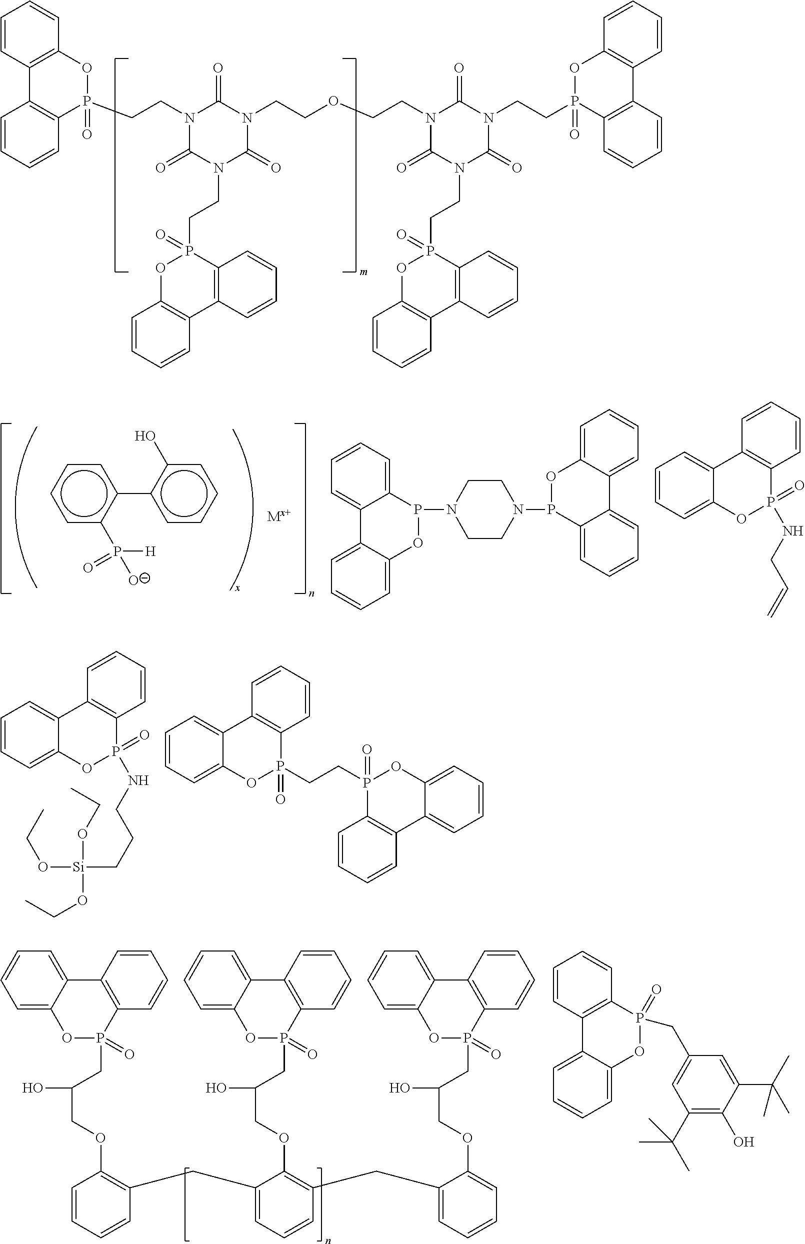

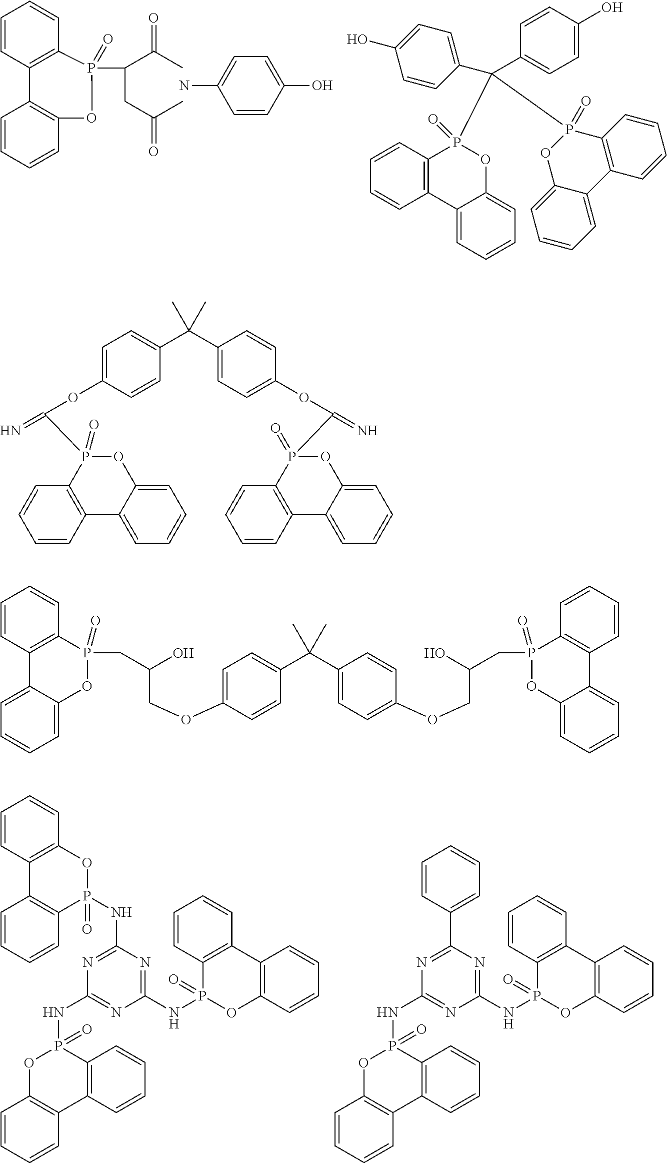

wherein M is a metal selected from the second, third, twelfth or thirteenth groups of the Periodic Table of the Elements, x=2 or 3, n≥10, m=0-25, R═H, halogen or an aliphatic or aromatic group having 1-32 C atoms and R1=H, C1-C6 alkyl or phenyl.

Products based on oxophosphorine oxide are, for example, available under the trade name Ukanol® from Schill und Seilacher GmbH. Further compounds may be prepared, for example, according to patent specifications WO 2013020696, WO 2010135398, WO03070736, WO2006084488, WO 2006084489, WO 2011000019, WO 2013068437, WO 2013072295.

Other suitable phosphorus-containing flame retardants are cyclic phosphonates of a structure according to one of the following formulas:

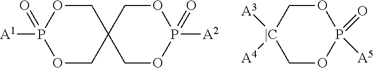

wherein A¹ and A² independently of one another represent a substituted or unsubstituted, straight-chain or branched alkyl group having 1 to 4 carbon atoms, substituted or unsubstituted benzyl, substituted or unsubstituted phenyl, substituted or unsubstituted is naphthyl, and wherein A³ and A⁴ independently of one another are methyl or ethyl and A⁵ is a straight-chain or branched alkyl group having 1 to 4 carbon atoms or a phenyl or benzyl group, each of which may have up to 3 methyl groups.

Cyclic phosphonates are available, for example, from the company Thor GmbH under the trade name Aflammit® or may be prepared according to EP 2450401.

Other synergistic phosphorus-containing flame retardants are phosphacenes, in particular polymeric phosphacenes. A corresponding product is available, for example, under the name SPB-100 from Otsuka Chemicals.

### b) Nitrogenous Flame Retardants

Preferred nitrogen-containing flame retardants are melamine polyphosphate, melamine cyanurate, melamine metal phosphates, poly-[2,4-(piperazin-1,4-yl)-6-(morpholin-4-yl)-1,3,5-triazine] and ammonium polyphosphate. These compounds are commercial products and are available under the trade names Melapur® from BASF SE, Budit® from Budenheim Chemische Fabrik, Exolit® from Clariant, Safire® from Huber Chemicals or MCA PPM Triazine from MCA Technologies GmbH.

c) Preferred Sulphur-Containing Flame Retardants are, for Example, the Following Compounds

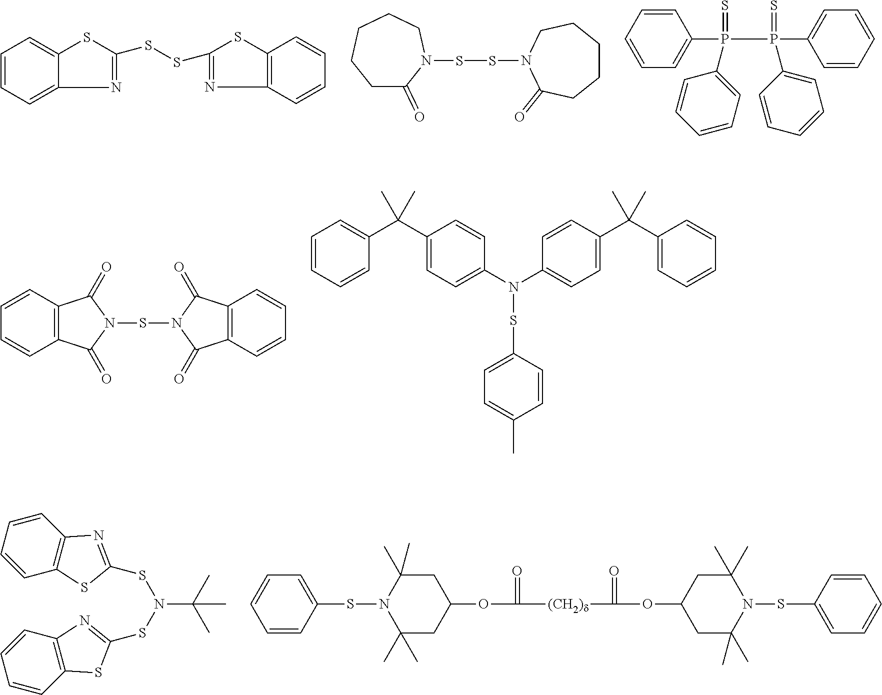

Very particularly preferred flame retardants are halogen-free and are the following compounds:

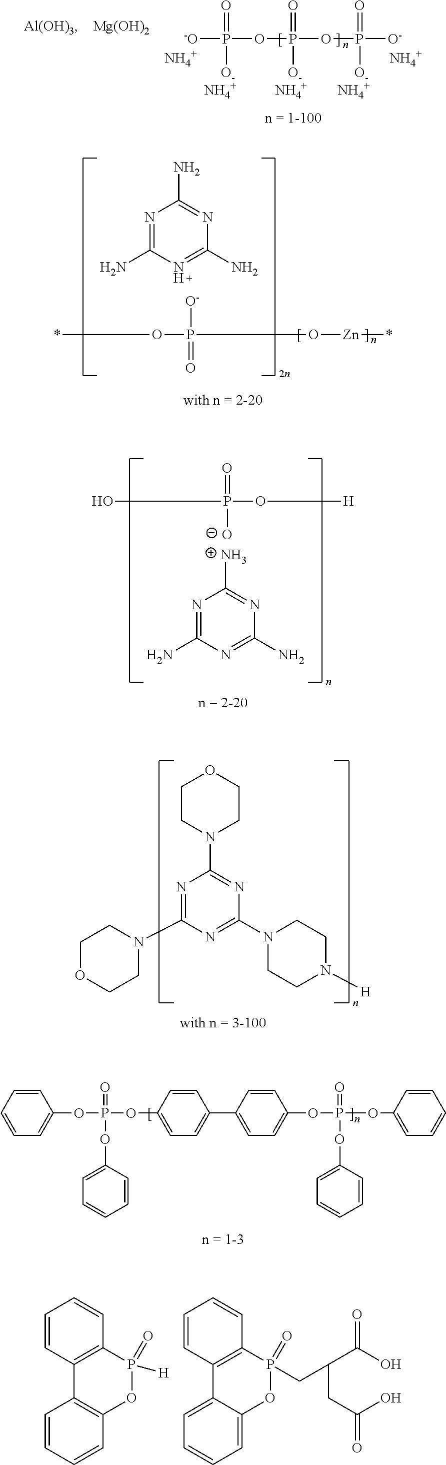

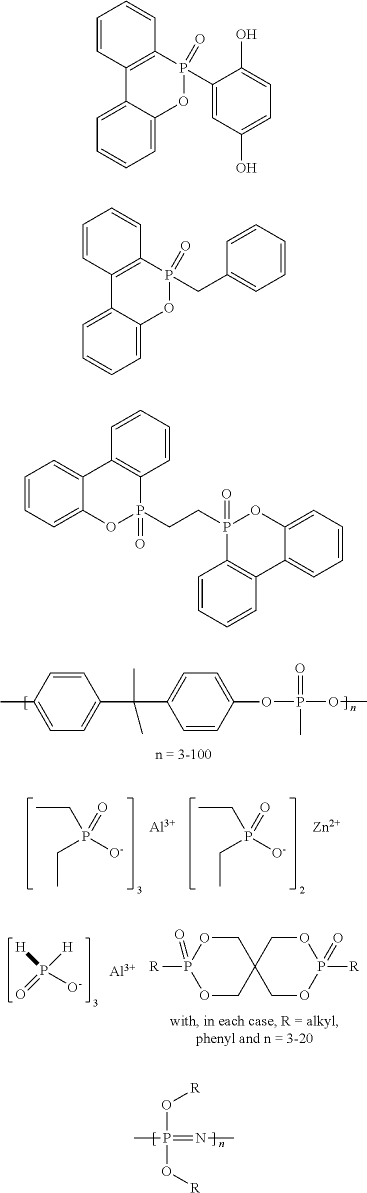

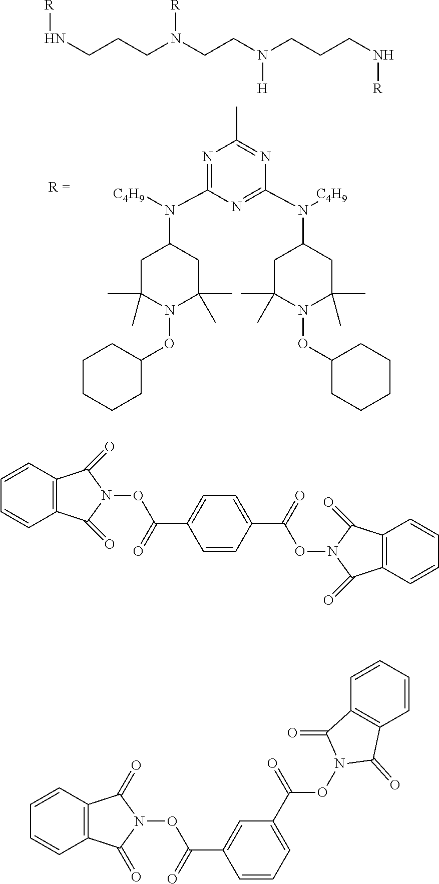

Suitable lubricants and processing aids are, for example, polyethylene waxes, polypropylene waxes, salts of fatty acids such as calcium stearate, zinc stearate or salts of montan waxes, amide waxes such as erucic acid amide or oleic acid amides, fluoropolymers, silicones or neoalkoxytitanates and zirconates.

Suitable heat stabilizers, in particular for PVC recyclates, are for example metal soaps of divalent metals such as Ba, Zn, Ca, e.g., zinc stearate, calcium stearate, organo tin compounds, e.g., methyl and octyl tin compounds such as dioctyl tin bis isooctyl thioglycolate or dioctyl tin maleate aminouracils, aminocrotonic acid esters, perchlorate salts and, as co-stabilizers, phosphites, epoxides, polyols, diketones, dihydropyridines, hydrotalcites, zeolites.

Suitable pigments may be inorganic or organic in nature. Inorganic pigments are, for example, titanium dioxide, zinc oxide, zinc sulfide, iron oxide, ultramarine, carbon black; organic pigments are, for example, anthraquinones, anthanthrones, benzimidazolones, quinacridones, diketopyrrolopyrroles, dioxazines, indanthrones, isoindolinones, azo compounds, perylenes, phthalocyanines or pyranthrones. Other suitable pigments are metal-based effect pigments or metal-oxide-based pearlescent pigments.

Suitable optical brighteners are, for example, bisbenzoxazoles, phenylcoumarins or bis(styryl)biphenyls, and in particular optical brighteners of the formulas:

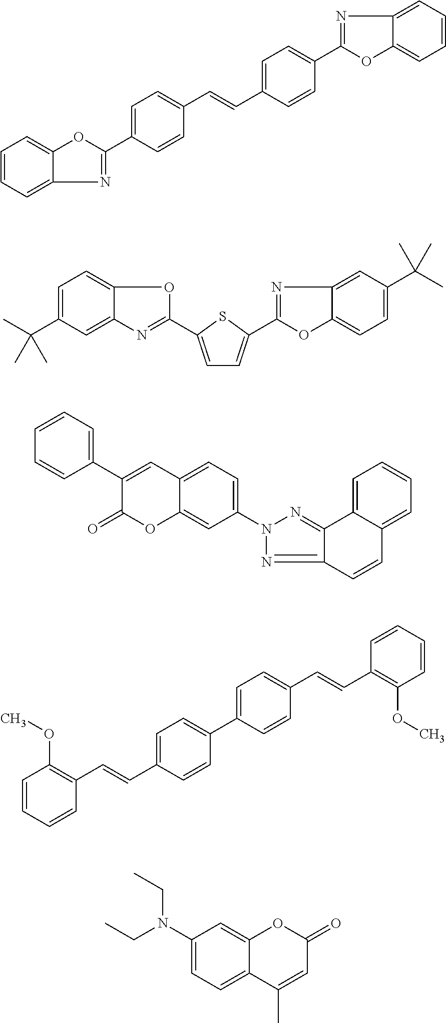

Suitable filler deactivators are, for example, polysiloxanes, polyacrylates, in particular block copolymers such as polymethacrylic acid-polyalkylene oxide or polyglycidyl (meth)acrylates and their copolymers, for example with styrene, and epoxides, for example of the following structures:

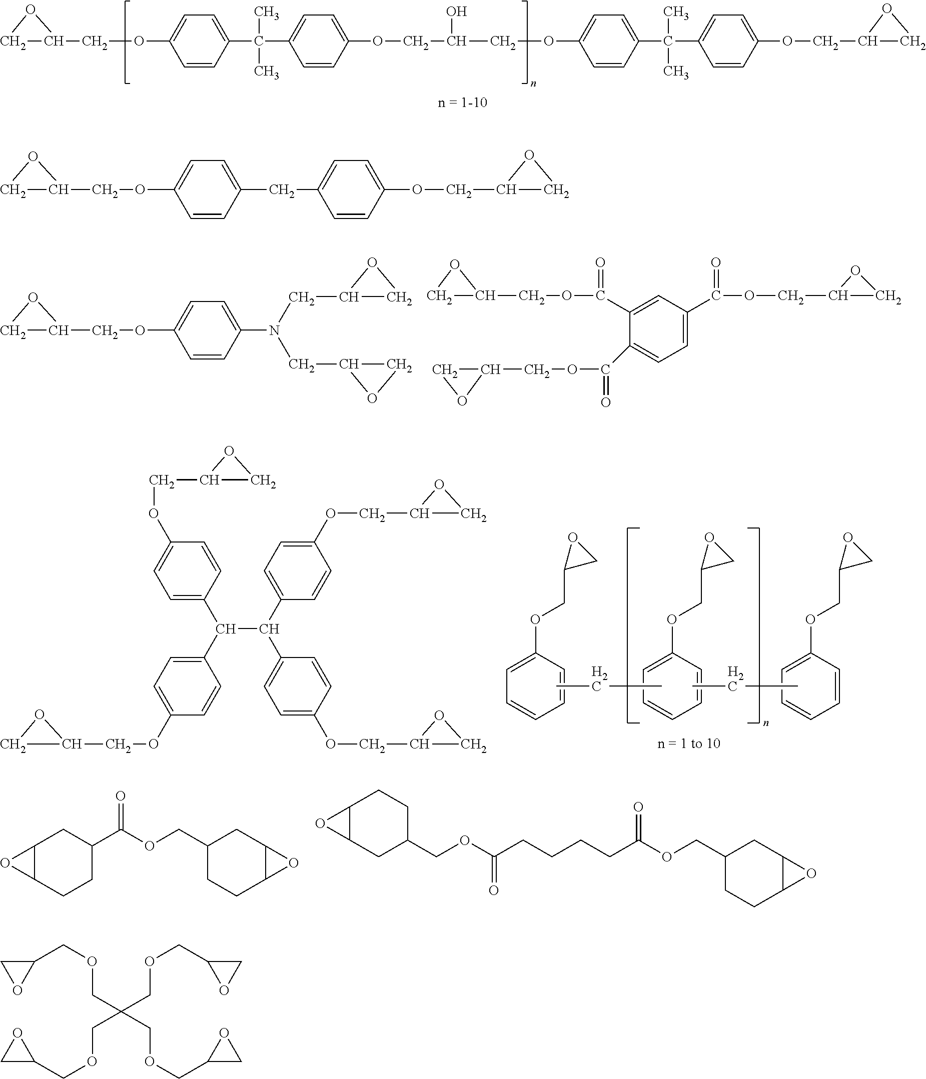

Suitable antistatic agents are, for example, ethoxylated alkylamines, fatty acid esters, alkyl sulfonates and polymers that form a co-continuous network with the polymer matrix, such as polyetheramides, polyesteramides, polyether ester ramides or polyether block copolymers, optionally with the addition of ionically conducting metal salts.

Suitable antiozonants are the above-mentioned amines such as N,N′-diisopropyl-p-phenylenediamine, N,N′-di-sec-butyl-p-phenylenediamine, N,N′-bis(1,4-dimethylpentyl)-p-phenylenediamine, N,N′-dicyclohexyl-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine.

Suitable rheology modifiers e.g., for the preparation of controlled rheology polypropylene (CR-PP) are, for example, peroxides, alkoxyamine esters, oxyimide sulfonic acid esters and in particular the following structures:

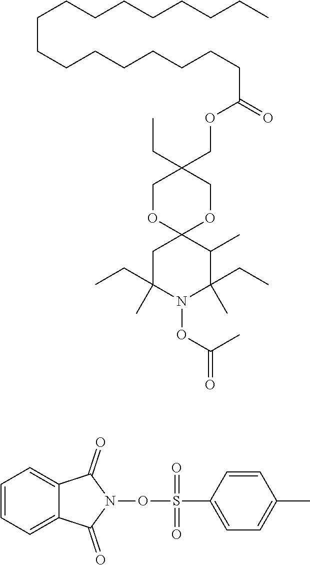 [SMILES: CCCCCCCCCCCCCCCCCC(=O)OCC1(CC)COC2(CC(C)(CC)N(OC(C)=O)C(C)(CC)C2C)OC1 ; Cc1ccc(S(=O)(=O)ON2C(=O)c3ccccc3C2=O)cc1]

Suitable additives for the molecular weight build-up of polycondensation polymers (chain is extenders) are diepoxides, bis-oxazolines, bis-oxazolones, bis-oxazines, diisocyanates, dianhydrides, bis-acyl lactams, bis-maleimides, dicyanates, carbodiimides and polycarbodiimides. Other suitable chain extenders are polymeric compounds, such as polystyrene-polyacrylate-polyglycidyl (meth)acrylate copolymers, polystyrene-maleic anhydride copolymers and polyethylene-maleic anhydride copolymers.

Suitable additives for increasing electrical conductivity are, for example, the aforementioned antistatic agents, carbon black and carbon compounds such as carbon nanotubes and graphene, metal powders, such as for example copper powder, and conductive polymers, such as polypyrroles, polyanilines and polythiophenes.

Suitable infrared-active additives are, for example, aluminosilicates, hydrotalcites or colouring agents such as phthalocyanines or anthraquinones.

Suitable crosslinking agents are, for example, peroxides like dialkyl peroxides, alkylaryl peroxides, peroxyesters, peroxycarbonates, diacylproxides, peroxyketals, silanes, such as e.g., vinyltrimethoxysilane, vinyltriethoxysilane, vinyltriacetoxysilane, vinyltris(2-methoxyethoxy)silane, 3-methacryloyloxypropyltrimethoxysilane, vinyldimethoxymethylsilane or ethylene-vinylsilane copolymers.

Suitable prodegradants are additives that specifically accelerate or control the degradation of a polymer in the environment. Examples are transition metal fatty acid esters, e.g., of manganese or iron, which accelerate an oxidative and/or photooxidative degradation for example of polyolefins or enzymes which induce a hydrolytic degradation for example of is aliphatic polyesters.

Suitable chemical blowing agents are, for example, azo compounds such as
azodicarboxylic acid diamide, sulfonyl semicarbazides such as p-toluenesulfonyl semicarbazide, tetrazoles such as 5-phenyl tetrazole, hydrazides such as p-toluenesulfonyl hydrazide, 4,4′-oxibis(benzenesulfonyl)hydrazide, N-nitroso compounds such as N,N′-dinitrosopentamethylene tetramine or carbonates such as sodium hydrogen carbonate or zinc carbonate.

Suitable slip agents include amide waxes such as erucic acid amide or oleic acid amide.

Suitable anti-blocking agents are, for example, silica, talc or zeolites.

Suitable antifogging additives are for example ethoxylated sorbitan esters, ethoxylated fatty acid alcohols or ethoxylated alkylamine esters.

Suitable biocides are, for example, quaternary ammonium salts or silver salts, colloidal silver or silver complexes or also derivatives of natural substances such as chitosan

Suitable aldehyde scavengers are amines, hydroxylamines, polyvinyl alcohol, zeolites or cyclodextrins, suitable formaldehyde scavengers are melamine derivatives such as benzoguanamine or urea derivatives such as allantoin.

Suitable odour-binding or odour-preventing substances are silicates such as calcium silicate, zeolites or salts of hydroxy fatty acids such as zinc riceneolate.

Suitable marking agents are, for example, fluorescent dyes or rare earths.

Suitable nucleating agents are talc, alkali or alkaline earth salts of mono- and polyfunctional carboxylic acids, such as benzoic acid, succinic acid, adipic acid, for example sodium benzoate, zinc glycerolate, aluminium hydroxy-bis(4-tert-butyl)benzoate, 2,2′-methylene-bis-(4,6-di-tert-butylphenyl)phosphate, as well as trisamides and diamides, such as trimesic acid tricyclohexylamide, trimesic acid tri(4-methylcyclohexylamide), trimesic acid tri(tert.butylamide), N,N′,N″-1,3,5-benzenetriyltris(2,2-dimethyl-propanamide) or 2,6-naphthalenedicarboxylic acid dicyclohexylamide.

Suitable antinucleating agents are azine dyes such as nigrosine or ionic liquids,

Suitable additives for increasing the thermal conductivity of plastic recyclates are, for example, inorganic fillers such as boron nitride, aluminium nitride, aluminium oxide, aluminium silicate, silicon carbide but also carbon nanotubes (CNT).

Suitable impact modifiers are usually selected for the particular recyclate and are selected for example from the group of functionalized or non-functionalized polyolefins, such as ethylene copolymers such as EPDM or maleic anhydride or styrene-acrylonitrile-modified EPDM, glycidyl-methacrylate-modified ethylene-acrylate copolymers or also ionomers, core-shell polymers for example based on MBS (methacrylate-butadiene-styrene copolymer) or acrylester-polymethyl methacrylate, thermoplastische elastomers (TPE) for example based on styrene-block copolymers (styrene-butadiene (SB), styrene-butadiene-styrene (SBS) optionally hydrated (SEBS) or modified by maleic anhydride (SEBS-g-MAH), thermoplastic polyurethanes, copolyesters or copolyamides.

Suitable demoulding aids are, for example, silicones, soaps and waxes such as montan waxes.

In another aspect, the present invention relates to a thermoplastic recyclate composition containing or consisting of at least one thermoplastic recyclate, and at least one sulphur-containing amino acid.

According to a preferred embodiment, the at least one sulphur-containing amino acid, in relation to the totality of the thermoplastic recyclates, is used in a weight ratio of 0.01 to 10.00 wt. %, preferably 0.02 to 5.00 wt. %, particularly preferably 0.05 to 2.00 wt. %.

Preferably, the at least one sulphur-containing amino acid is selected from the group consisting of methionine or a methionine derivative or cystine, as well as their alkali, alkaline earth, Al or Zn salts.

The thermoplastic recyclate composition according to the present invention may additionally contain at least one primary and/or secondary antioxidant.

With regard to specific embodiments concerning the content and/or type and nature of the respective sulphur-containing amino acids or the further additives, reference is made to the above explanations.

The present invention also relates to a stabilizer composition for stabilizing thermoplastic recyclates, in particular against oxidative, thermal and/or actinic degradation, consisting of at least one sulphur-containing amino acid, wherein the at least one sulphur-containing amino acid is preferably selected from the group consisting of methionine or a methionine derivative or cystine, as well as alkali, alkaline earth, Al or Zn salts thereof, as well as at least one primary and/or secondary antioxidant.

According to a preferred embodiment, the totality of the at least one sulphur-containing amino acid to the totality of the at least one primary and/or secondary antioxidant is present in a weight ratio of 10:1 to 1:10, further preferably 5:1 to 1:5, particularly preferably 2:1 to 1:2.

The present invention also relates to a masterbatch or a concentrate containing 10 to 90 wt. % of a stabilizer composition according to any one of the two preceding claims, and 90 to 10 wt. % of a thermoplastic, in particular a plastic recyclate, a virgin plastic or a mixture thereof.

Another aspect of the present invention relates to a moulding compound or moulded part producible from a thermoplastic recyclate composition according to the invention, in particular a polyolefin recyclate composition, in particular in the form of injection moulded parts, sheets or foils, foams, fibres, cables and tubes, profiles, hollow bodies, tapes, membranes, such as geomembranes, or adhesives, which are produced via extrusion, injection moulding, blow moulding, calendering, pressing methods, spinning processes, rotomoulding, for example
packaging, for example for foodstuffs, detergents, cosmetics, adhesives in the form is of films, bottles, bags, screw-top vessels,
storage and transport containers such as boxes, crates, barrels, buckets, pallets,
automotive, railway, aircraft, ship and machine parts, such as bumpers, trim parts, fittings and functional parts, upholstery,
construction applications such as profiles, construction sheets, cable ducts, house cladding, noise barriers, drainage channels, profiled boards, floor coverings,
road and landscaping applications such as beacon bases, posts, barriers, geotextiles,
electrical and electronic applications such as housing parts and accessories of televisions, computers, mobile phones, washing machines, dishwashers, coffee machines, drills, connectors, storage media,
cable insulation,
pipes for, for example, water, gas, sewage, irrigation, drainage pipes,
furniture and textile applications, such as curtains and upholstery, worktops,
household, leisure and sporting articles such as balls, tennis rackets, skis, flower pots, rain barrels, clothes hangers,
agricultural applications such as mulch, tunnel or perforated films, plant pots, or
plant protection applications such as the encapsulation of active ingredients and biologically active substances, or

A further aspect of the present invention relates to a method for the stabilization, in particular for the oxidative, thermal and/or actinic stabilization of thermoplastic recyclates by addition, additivation or incorporation of at least one sulphur-containing amino acid, a stabilizer composition according to the invention, or a masterbatch according to the invention in a thermoplastic recyclate.

The present invention additionally relates to the use of the thermoplastic recyclate composition according to the invention for the production of moulded parts, in particular in the form of injection moulded parts, sheets or films, foams, fibres, cables and tubes, profiles, hollow bodies, tapes, membranes, such as geomembranes, or adhesives, which are is produced via extrusion, injection moulding, blow moulding, calendering, pressing methods, spinning processes, rotomoulding, for example
packaging, for example for food, detergents, cosmetics, adhesives in the form of films, bottles, bags, screw-top containers,
storage and transport containers such as boxes, crates, barrels, buckets, pallets,
automotive, railway, aircraft, ship and machine parts, such as bumpers, trim parts, fittings and functional parts, upholstery,
construction applications such as profiles, construction sheets, cable ducts, house cladding, noise barriers, drainage channels, profiled boards, floor coverings,
road and landscaping applications such as beacon bases, posts, barriers, geotextiles,
electrical and electronic applications such as housing parts and accessories of televisions, computers, mobile phones, washing machines, dishwashers, coffee machines, drills, connectors, storage media,
cable insulation,
pipes for, for example, water, gas, sewage, irrigation, drainage pipes,
furniture and textile applications, such as curtains and upholstery, worktops,
household, leisure and sporting articles such as balls, tennis rackets, skis, flower pots, rain barrels, clothes hangers,
agricultural applications such as mulch, tunnel or perforated films, plant pots, or
plant protection applications such as the encapsulation of active ingredients and biologically active substances, or

Preferably, the sulphur-containing amino acid, the stabilizer composition or the masterbatch, which may each be present as a powder, liquid, oil, compacted, on a carrier material, as granules, solution or flakes, is mixed with the polymer to be stabilized, and the polymer matrix is transferred into the melt and then cooled. Alternatively, it is also possible for this purpose to introduce the sulphur-containing amino acid, the stabilizer composition or the masterbatch in a molten state into a polymer melt.

In the event that further components are added to the polymer composition, these may be added to the polymers separately, in the form of liquids, powders, granules or compacted products, or together with the sulphur-containing amino acid, the stabilizer composition or the masterbatch as described above.

The incorporation of the sulphur-containing amino acid, the stabilizer composition or the masterbatch and optionally the additional additives into the plastic is carried out by conventional processing methods, preferably by mixers, kneaders or extruders. Preferred processing machines are extruders such as single screw extruders, twin screw extruders, planetary roller extruders, ring extruders, and co-kneaders, which are preferably equipped with vacuum degassing. The processing may take place here under air or, if necessary, under inert gas conditions.

The plastics compositions containing the sulphur-containing amino acid, the stabilizer composition or the masterbatch may be processed by conventional plastics processing methods in continuous and discontinuous processes, such as extrusion, calendering, blow moulding, pultrusion, injection moulding, pressing, transfer moulding, casting, blow moulding, rotational moulding, thermoforming, sintering, foaming or also by additive manufacturing processes for the production of granular material, moulded parts, semi-finished products, fibres and films.

Suitable extruders are piston extruders and screw extruders, single-screw extruders, twin-screw extruders, multi-screw extruders, planetary roller extruders, in particular for the production of plastics granular materials, pipes, rods, tubes, profiles, sheathing, board, films, V-belts, toothed belts, seals, foam boards (XPS), fibres and filaments for additive manufacturing processes.

Suitable injection moulding machines may be hydraulic or electromechanical and may comprise multi-component injection moulding and in-mould processes.

Moulded parts produced by injection moulding are, for example, bottles, containers, screw-top vessels, crates, barrels, buckets, pallets, technical parts for cars and transport such as is bumpers, trim parts, handles, headlight covers, fittings and functional parts, electrical and electronic applications such as housing parts and accessories for televisions, computers, mobile phones, washing machines, dishwashers, coffee machines, drills, plug connections, storage media, household, leisure and sporting articles such as planters, clothes hangers, toy figures, model making parts, components for furniture such as brackets.

Parts produced by blow moulding are in particular hollow bodies such as bottles, fuel tanks, canisters, washing water tanks and expansion tanks.

Parts produced by rotational moulding are in particular tanks such as fuel oil tanks, and rainwater tanks, housings for machines, transport containers, leisure and water sports articles such as kayaks Calendering is used in particular to produce films such as decorative films, wallpapers and floor coverings.

Additive manufacturing processes include, for example, binder jetting (BJ), laser sintering (LS), selective laser melting (SLM), electron beam melting (EBM), fused deposition modelling (FDM), fused filament fabrication (FFF), multi-jet modelling (MJM), poly-jet modelling (PJM), layer laminated manufacturing (LLM), thermal transfer sintering (TTS), digital light processing (DLP),
photopolymer jetting (PJ) and stereolithography (SL).

The present invention is described in greater detail with reference to the following examples, without limiting the present invention to the specific examples presented.

To test the effect of the stabilizer composition according to the invention, a post-consumer polypropylene recyclate made from ground-up battery boxes (supplier: BSB Braubach) was circulated in the melt at 210° C. in a twin-screw micro extruder (Micro 5 cc, manufacturer DSM) in continuous mode at 200 rpm for 30 minutes. After 10/20/30 minutes, the force take-up is measured. The force is a measure of the toughness of the melt and thus a measure of the molecular weight. The higher the remaining force, the lower the degradation of the polymer and the higher the polymer stability or the effect of the stabilizer addition. The mean value of the residual force from 2 tests is given in each case.

| | | Residual force after |
|---|---|---|
| | Additive | 10/20/30 minutes |
| Comparative | recyclate without | 77/49/28 |
| example 1 | additive | |
| Example 1 | 0.125% AO-1 + 0.125% | 83/68/56 |
| according to the | P-1 + 0.25% methionine | |
| invention | | |
| Example 2 | 0.125% AO-1 + 0.125% | 92/81/71 |
| according to the | P-1 + 0.25% cysteine | |
| invention | | |
| Example 3 | 0.125% AO-1 + 0.125% | 92/83/75 |
| according to the | P-1 + 0.25% cystine | |
| invention | | |
| Example 4 | 0.125% AO-1 + 0.125% | 86/72/62 |
| according to the | AL-1 + 0.25% methionine | |
| invention | | |
| Example 5 | 0.125% AO-2 + 0.125% | 84/65/50 |
| according to the | AL-1 + 0.25% methionine | |
| invention | | |
| Example 6 | 0.25% AO-2 + 0.25% | 87/71/58 |
| according to the | methionine | |
| invention | | |

AO-1: pentaerythritol tetrakis[3-[3,5-di-tert-butyl-4-hydroxyphenyl]propionate (primary antioxidant)
AO-2: dodecyl gallate (primary antioxidant)
P-1: tris(2,4-di-tert.-butylphenyl)phosphite (secondary antioxidant)
AL-1: erythritol (alditol costabilizer)

In a second series of tests, the PP recyclate was processed with further compositions according to the invention analogous to Examples 1-6 and the following results were obtained:

| | | Residual force after |
|---|---|---|
| | Additive | 10/20/30 minutes |
| Comparative | Recyclate without | 75/49/28 |
| example 2 | additive | |
| Example 7 | 0.25% AO-1 + 0.25% | 89/83/76 |
| according to the | cystine | |
| invention | | |
| Example 8 | 0.25% AO-3 + 0.25% | 89/81/74 |
| according to the | cystine | |
| invention | | |
| Example 9 | 0.25% AO-4 + 0.25% | 93/90/85 |
| according to the | cystine | |
| invention | | |
| Example 10 | 0.25% P-1 + 0.25% | 91/82/71 |
| according to the | cystine | |
| invention | | |
| Example 11 | 0.25% P-2 + 0.25% | 92/88/84 |
| according to the | cystine | |
| invention | | |
| Example 12 | 0.25% P-3 + 0.25% | 92/85/73 |
| according to the | cystine | |
| invention | | |

AO-3: 1,3,5-trimethyl-2,4,5-tris(3′,5′-ditert-butyl)-4′-hydroxybenzyl)-benzene (primary AO)
AO-4: ethylene-1,2-bis[3,3-bis(3-tert-butyl-4-hydroxyphenyl)butyrate (primary AO)
P-2: 3,9-bis(2,4-di-tert-butylphenoxy)-2,4,8,10-tetraoxa-3,9-diphosphaspiro[5.5]undecane (secondary AO)
P-3: 3,9-bis[2,4-bis(1-methyl-1-phenylethyl)phenoxy]-2,4,8,10-tetraoxa-3,9-diphosphaspiro[5.5]undecane (secondary AO)

Compared to the comparative example, it is clear that combinations of the sulphur-containing amino acid of the invention both with primary antioxidants (AO) and secondary antioxidants (P) provide significant stabilization against oxidative degradation of recyclates.

In a further series of tests, the PP recyclate was processed exclusively with the addition of a sulphur-containing amino acid analogous to Examples 1-6 and the following results were obtained:

| | | Residual force after |
|---|---|---|
| | Additive | 10/20/30 minutes |
| Comparative | recyclate without | 75/49/28 |
| example 2 | additive | |
| Example 13 | 0.25% cystine | 83/71/60 |
| according to the | | |
| invention | | |
| Example 14 | 0.50% cystine | 85/74/64 |
| according to the | | |
| invention | | |
| Example 15 | 0.75% cystine | 85/74/65 |
| according to the | | |
| invention | | |

It is shown that the addition of the sulphur-containing amino acid alone has a stabilizing effect on a recyclate, but that the synergistic combination with a secondary or primary antioxidant is advantageous.

Similarly, an LLDPE/LDPE film recyclate containing a combination of 0.25% cystine with 0.25% octadecyl 3-(3,5-di-tert-butyl-4-hydroxyphenyl)propionate was processed at 200° C. for 30 minutes in continuous mode. Compared to the film recyclate without additive, there is an increased melt stability.

Similarly, a PLA recyclate from beverage cups containing a combination of 0.25% cystine with 0.25% octadecyl 3-(3,5-di-tert-butyl-4-hydroxyphenyl)propionate was processed at 200° C. for 30 minutes in continuous mode. Compared to the recyclate without additive, there is an increased melt stability.

1-18. (canceled)

19. A method of providing stabilization to a thermoplastic recyclate, the method comprising combining the thermoplastic recyclate with at least one sulphur-containing amino acid.

20. The method of claim 19, which provides stabilization against oxidative, thermal, and/or actinic degradation.

21. The method of claim 19, wherein the at least one sulphur-containing amino acid is combined in a weight ratio of 0.01 to 10.00 wt. % in relation to the weight of the thermoplastic recyclate.

22. The method of claim 19, wherein the at least one sulfur-containing amino acid is selected from the group consisting of methionine, methionine derivatives, cystine, and alkali, alkaline earth, Al, and Zn salts thereof.

23. The method according to claim 19, wherein the thermoplastic recyclate is further combined with at least one primary and/or at least one secondary antioxidant.

24. The method according to claim 23, wherein the at least one primary antioxidant is selected from the group consisting of phenolic antioxidants, (semi-)aromatic amines, hydroxylamines, lactones, and isoindolo[2,1-A]quinazolines.

25. The method according to claim 23, wherein the at least one secondary antioxidant is selected from the group consisting of phosphites, phosphonites, and organo-sulphur compounds.

26. The method according to claim 19, wherein the thermoplastic recyclate is selected from the group consisting of:
a) recycled polymers of olefins or diolefins,
b) recycled styrene polymers,
c) recycled polymers of unsaturated esters,
d) recycled polymers of unsaturated alcohols and derivatives,
e) recycled polyacetals,
f) recycled polymers of cyclic ethers,
g) recycled polyphenylene oxides and blends thereof,
h) recycled thermoplastic polyurethanes (TPU) and polyureas,
i) recycled polyamides, blends of different polyamides or blends of polyamides and polyolefins,
j) recycled polyimides, polyamideimides, polyetherimides, polyesterimides, poly(ether)ketones, polysulfones, polyethersulfones, polyarylsulfones, polyphenylene sulphides, polybenzimidazoles, and polyhydantoins,
k) recycled polyesters of aliphatic or aromatic dicarboxylic acids and diols or of hydroxy-carboxylic acids,
l) recycled polycarbonates, polyester carbonates, as well as blends thereof,
m) recycled cellulose derivatives,
n) recycled linear polyethers from epoxides, and
p) mixtures, combinations or blends of two or more of the aforementioned polymers.

27. The method according to claim 26, wherein the recycled polymers are selected from the group consisting of:
a) LDPE, LLDPE, VLDPE, ULDPE, MDPE, HDPE, UHMWPE, metallocene-PE (m-PE), polypropylene, polyisobutylene, poly-4-methyl-pentene-1, polybutadiene, polyisoprene, natural rubber (NR), polycyclooctene, polypropylene-polyethylene (EP), EPM or EPDM with 5-ethylidene-2-norbornene as comonomer, ethylene-vinyl acetate (EVA) copolymer, ethylene acrylic ester copolymers, ethylene-acrylic acid-glycidyl (meth)acrylate copolymer, polypropylene-graft-maleic anhydride copolymer, polypropylene-graft-acrylic acid copolymer, polyethylene-graft-acrylic acid copolymer, polyethylene-polybutyl acrylate-graft-maleic anhydride as well as blends thereof with LDPE/LLDPE, and long-chain branched polypropylene copolymers produced with alpha-olefins as comonomers,
b) polystyrene, polymethylstyrene, poly-alpha-methylstyrene, polyvinylnaphthalene, polyvinylbiphenyl, polyvinyltoluene, styrene-butadiene (SB), styrene-butadiene-styrene (SBS), styrene-ethylene-butylene-styrene (SEBS), styrene-ethylene-propylene-styrene, styrene isoprene, styrene-isoprene-styrene (SIS), styrene-butadiene-acrylonitrile (ABS), styrene-acrylonitrile (SAN), styrene-acrylonitrile-acrylate (ASA), styrene-ethylene, styrene-maleic anhydride polymers including corresponding graft copolymers, graft copolymers of methyl methacrylate, styrene butadiene, and ABS (MABS), and hydrogenated polystyrene derivatives thereof,
c) polymethyl methacrylate (PMMA), polybutyl acrylate, polylauryl acrylate, polystearyl acrylate, polyglycidyl acrylate, polyglycidyl methacrylate, polyacrylonitrile, polyacrylamides, and polyacrylonitrile-polyalkyl acrylate,
d) polyvinyl alcohol, polyvinyl acetate, polyvinyl butyral, polyallyl phthalate, and polyallyl melamine,
e) polyoxymethylene (POM) and copolymers and blends with polystyrene or polyamides,
f) polyethylene glycol, polypropylene glycol, polyethylene oxide, polypropylene oxide, and polytetrahydrofuran,
g) polyphenylene oxides and blends thereof with polystyrene and/or polyamides,
h) thermoplastic polyurethanes (TPU) formed from hydroxy-terminated polyethers or polyesters and aromatic or aliphatic isocyanates, and polyureas,
i) polyamide-6, 6.6, 6.10, 4.6, 4.10, 6.12, 10.10, 10.12, 12.12, polyamide 11, polyamide 12, polyphthalamides, blends of PA-6 and PA 6.6, and blends of polyamides and polyolefins,
j) polyimides, polyamideimides, polyetherimides, polyesterimides, poly(ether)ketones, polysulfones, polyethersulfones, polyarylsulfones, polyphenylene sulphides, polybenzimidazoles, and polyhydantoins,
k) polyethylene terephthalate (PET), polybutylene terephthalate (PBT), polypropylene terephthalate (PPT), polyethylene naphthylate (PEN), poly-1,4-dimethylolcyclohexane terephthalate, polyhydroxybenzoate, polyhydroxynaphthalate, polylactic acid (PLA), polyhydroxybutyrate (PHB), polyhydroxyvalerate (PHV), polybutylene succinate (PBS), poly(butylene succinate-co-adipate) (PBSA), polyethylene succinate, polytetramethylene succinate, and poly caprolactone,
l) PC/ABS, PC/PBT, PC/PET/PBT, and PC/PA,
m) cellulose nitrate, cellulose acetate, cellulose propionate, and cellulose butyrate,
n) linear polyethers from epoxides, and
p) mixtures, combinations or blends of two or more of the aforementioned polymers.

28. The method according to claim 19, wherein the at least one sulphur-containing amino acid is combined with at least one additive.

29. The method according to claim 28, wherein the at least one additive is selected from the group consisting of UV absorbers, light stabilizers, metal deactivators, filler deactivators, antiozonants, nucleating agents, antinucleating agents, impact modifiers, lubricants, rheology modifiers, thixotropic agents, chain extenders, processing aids, demoulding aids, flame retardants, pigments, dyes, optical brighteners, antimicrobial agents, antistatic agents, slip agents, anti-blocking agents, coupling agents, cross-linking agents, anti-cross-linking agents, hydrophilizing agents, hydrophobizing agents, adhesion promoters, dispersants, compatibilizers, oxygen scavengers, acid scavengers, blowing agents, degradation additives, defoaming agents, odor scavengers, marking agents, antifogging agents, fillers, and reinforcing agents.

30. A thermoplastic recyclate composition comprising at least one thermoplastic recyclate and at least one sulphur-containing amino acid.

31. The thermoplastic recyclate composition according to claim 30, wherein the at least one sulphur-containing amino acid, in relation to the totality of the thermoplastic recyclate, is present in a weight ratio of 0.01 to 10.00 wt. %.

32. The thermoplastic recyclate composition according to claim 30, wherein the at least one sulphur-containing amino acid is selected from the group consisting of methionine, a methionine derivative, cystine, and alkali, alkaline earth, Al, and Zn salts thereof.

33. The thermoplastic recyclate composition according to claim 30, which further includes at least one primary and/or secondary antioxidant.

34. A stabilizer composition comprising a thermoplastic recyclate, at least one sulphur-containing amino acid, and at least one primary and/or secondary antioxidant.

35. The stabilizer composition according to the claim 34, wherein
the totality of the at least one sulphur-containing amino acid to the totality of the at least one primary and/or secondary antioxidant is present in a weight ratio of 10:1 to 1:10.

36. A masterbatch containing 10 to 90 wt. % of a stabilizer composition according to claim 34, and 90 to 10 wt. % of a thermoplastic.

37. A moulding compound or moulded part produced from a thermoplastic recyclate composition according to claim 30.

38. The moulding compound or moulded part according to claim 37, which is an injection moulded part, a sheet, a foil, a foam, a fiber, a cable, a tube, a profile, a hollow body, a tape, a membrane, or an adhesive.

39. A method of producing moulded parts comprising utilizing the thermoplastic recyclate composition according to claim 30.
